(19) United States
(12) Patent Application Publication
(10) Pub. No.: US 2026/0038861 A1
(43) Pub. Date: Feb. 5, 2026

(54) ANOLYTES COMPRISING ALKANOLAMINE-BASED LIGANDS FOR REDOX FLOW BATTERY SYSTEMS

(71) Applicant: Battelle Memorial Institute, Richland, WA (US)

(72) Inventors: Aaron Hollas, Richland, WA (US); Guosheng Li, Richland, WA (US); Gabriel Nambafu, Richland, WA (US); David Reed, Richland, WA (US)

(73) Assignee: Battelle Memorial Institute, Richland, WA (US)

(21) Appl. No.: 18/791,132

(22) Filed: Jul. 31, 2024

(51) Int. Cl. H01M 8/18

(52) U.S. Cl. CPC H01M 8/188; H01M 2300/0002

(57) ABSTRACT

Disclosed herein are anolytes comprising alkanolamine-base ligands and an iron-ion component. Also disclosed herein is a redox flow battery system comprising an anolyte comprising the alkanolamine-based ligand of the present disclosure, a catholyte; and an ion selective membrane disposed between the catholyte and anolyte. Also disclosed herein are methods of making and using the anolyte disclosed herein.

### ACKNOWLEDGMENT OF GOVERNMENT SUPPORT

This invention was made with government support under DE-AC0576RL01830 awarded by the U.S. Department of Energy. The government has certain rights in the invention.

### FIELD

The present disclosure concerns anolytes comprising alkanolamine-based ligands, as well as redox flow battery systems including the alkanolamine-based ligand, along with methods of making and using the same.

### BACKGROUND

Energy storage has garnered interest as a valuable tool to serve the present and future electric grid. Among the energy storage technologies, the redox flow battery presents multiple benefits. For example, the intrinsic safety of a system based on an aqueous electrolyte and the modular architecture that decouples power and energy, which allows simple scaling to multi-hour/day durations. However, the widespread implementation of vanadium redox flow battery is restricted by the sporadic cost and limited earth-abundance of vanadium.

Systems utilizing low-cost materials utilizing zinc, iron, and chromium have been investigated but present their own unique challenges. For example, all-iron based systems utilizing Fe⁰ as the anode have been investigated but this architecture cannot fully decouple power and capacity. Recent efforts have sought to utilize the Fe^{2+/3+} redox couple at both the cathode and anode by using ligands to alter the reduction potentials of iron. However, such ligands are prone to crossover through the cell membrane and react with the catholyte, which leads to cell death.

Accordingly, there is a need in the art for redox flow battery materials that can support Fe(III), reduce the proclivity of membrane towards membrane crossover, eliminate the need for multiple equivalents of additional free ligand in solution, and therefore increase cell lifetime.

### SUMMARY

Disclosed herein is an anolyte comprising an iron-ion component and an alkanolamine-based ligand having a structure according to Formula I,

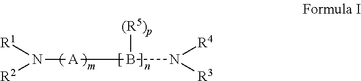

wherein: A is selected from acyclic aliphatic or acyclic heteroaliphatic; each B independently for each occurrence is acyclic aliphatic or acyclic heteroaliphatic; each of R¹, R², R³, and R⁴ independently is selected from hydrogen, aliphatic, or heteroaliphatic; R⁵ is selected from hydroxyl or heteroaliphatic; m is an integer selected from 0 or 1; n is an integer selected from 1 to 500; and each p independently for each occurrence is an integer selected from 0 or 1; provided that (i) if B is aliphatic and p is 0, then B is C₃₋₁₀ aliphatic; and (ii) at least two of R¹, R², R³, R⁴, and R⁵ independently comprise a heteroaliphatic group comprising at least two hydroxyl groups.

A redox flow battery system is also disclosed herein, the redox flow battery system comprising the anolyte disclosed herein; a catholyte; and an ion selective membrane disposed between the catholyte and anolyte.

Also disclosed herein is a method, comprising placing the anolyte disclosed herein in a redox flow battery system cell comprising a catholyte and an ion selective membrane; and producing an open circuit voltage ranging from 0.5 V to 2.0 V.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is a schematic showing aspects of a redox flow battery system disclosed herein, comprising a catholyte, an anolyte comprising an alkanolamine-based ligand, and an ion selective membrane disposed between the catholyte and anolyte.

FIGS. 2A and 2B are graphs illustrating the battery cycling data for a redox flow battery system using an anolyte comprising the alkanolamine ligand ET-N2-PD4 with 1 equivalent FeCl₃ at pH 11.3, 12.5, 13.1 (0.4 M metal complex), wherein FIG. 2A is a graph showing the discharge capacity and energy efficiency over repeated cycling and FIG. 2B is a graph showing the charge and discharge profiles at pH 11.3, 12.5, and 13.

FIGS. 3A and 3B are graphs illustrating the battery cycling data for a redox flow battery system using an anolyte comprising ET-N2-PD4 with 1 equivalent FeCl₃ at pH 14 (0.625 M, 12 mL) cycled at 20 mA/cm², wherein FIG. 3A is a graph showing the discharge capacity and energy efficiency over repeated cycling and FIG. 3B is a graph showing the charge and discharge profiles at pH 14.

FIGS. 4A and 4B are graphs illustrating battery cycling data for a redox flow battery system using an anolyte comprising alkanolamine ligand ET-N3-PD5 with 1 equivalent FeCl₃ at pH 14 (0.5 M, 10 mL), wherein FIG. 4A is a graph showing the discharge capacity and energy efficiency over repeated cycling and FIG. 4B is a graph showing the charge and discharge profiles at pH 14.

FIGS. 5A and 5B are graphs illustrating battery cycling data for a redox flow battery system using an anolyte comprising alkanolamine ligand Et-N3-PD3-PHS2 with 1 equivalent FeCl₃ at pH 13.2 (0.36 M, 7 mL), wherein FIG. 5A is a graph showing the discharge capacity and energy efficiency over repeated cycling and FIG. 5B is a graph the charge and discharge profiles at pH 13.2.

FIGS. 6A and 6B are graphs illustrating battery cycling data for a redox flow battery system using an anolyte comprising alkanolamine ligand Et-N6-PD8 with 2 equivalents FeCl₃ at pH 13.2 (0.67M [Fe], 0.33 M [ligand], 15 mL), wherein FIG. 6A is a graph showing the discharge capacity and energy efficiency over repeated cycling and FIG. 6B is a graph showing the charge and discharge profiles at pH 13.32.

FIGS. 7A and 7B are graphs illustrating battery cycling data for a redox flow battery system using an anolyte comprising alkanolamine ligand Et-N580-PD582 with at pH 13.14 (0.25 M [Fe], 0.02 M [ligand], 10 mL), wherein FIG. 7A is a graph showing the discharge capacity and energy efficiency over repeated cycling, and FIG. 7B is a graph showing the charge and discharge profiles at pH 13.14.

FIGS. 8A and 8B are graphs illustrating battery cycling data for a redox flow battery system using an anolyte comprising alkanolamine ligand Et-N18-PD20 with 4 equivalents FeCl₃ at pH 14 (0.4 M [Fe], 0.1 M [ligand], 10 mL), wherein FIG. 8A is a graph showing the discharge capacity and energy efficiency over repeated cycling, and FIG. 8B is a graph showing the charge and discharge profiles at pH 14.

FIGS. 9A and 9B are graphs illustrating battery cycling data for a redox flow battery system using an anolyte comprising alkanolamine ligand Et-N2-PD3-HE with 1 equivalent FeCl₃ at pH 13.10 (0.67 M, 15 mL), wherein FIG. 9A is a graph showing the discharge capacity and energy efficiency over repeated cycling, and FIG. 9B is a graph showing the charge and discharge profiles at pH 13.10.

FIGS. 10A and 10B are graphs illustrating battery cycling data for a redox flow battery using an anolyte comprising alkanolamine ligand HPr-N2-PD2-HE2 with 1 equivalent FeCl₃ at pH 13.19 (0.36 M, 7 mL), wherein FIG. 10A is a graph showing the discharge capacity and energy efficiency over repeated cycling, and FIG. 10B is a graph showing the charge and discharge profiles at pH 13.19.

FIGS. 11A and 11B are graphs illustrating battery cycling data for a redox flow battery system using an anolyte comprising alkanolamine ligand HPr-N2-GLUC2-Me2 with 1 equivalent FeCl₃ at pH 13.12 (0.5 M, 7 mL), wherein FIG. 11A is a graph showing the discharge capacity and energy efficiency over repeated cycling and FIG. 11B is a graph showing the charge and discharge profiles at pH 13.

FIGS. 12A-12C are graphs comparing the battery cycling data for a redox flow battery system using an anolyte comprising alkanolamine ligand Et-N2-PD4 (10 mmol) and FeCl₃ (10 mmol) with 6 equivalents NaOH and diluted to 10 mL versus a redox flow battery using an anolyte comprising triethanolamine (TEOA) (30 mmol) and FeCl₃ (10 mmol) with 6 equivalents NaOH and diluted to 20 mL; wherein FIG. 12A is a graph showing the discharge capacity for Et-N2-PD4 and TEOA, CE for Et-N2-PD4 and TEOA, and the EE for Et-N2-PD4 and TEOA; FIG. 12B is a graph showing the voltage profiles for Et-N2-PD4 and TEOA at cycles 1, 10, and 21; and FIG. 12C is an ¹H-NMR spectrum of the catholyte comprising TEOA and the ¹H-NMR spectrum of the catholyte comprising Et-N2-PD4.

### DETAILED DESCRIPTION

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

The methods described herein should not be construed as limiting in any way. Instead, the present disclosure is directed toward all novel and non-obvious features and aspects of the present disclosure, alone and in various combinations and sub-combinations with one another. The disclosed methods are not limited to any specific aspect or feature or combinations thereof, nor do the disclosed methods require that any one or more specific advantages be present or problems be solved. Any theories of operation are to facilitate explanation, but the methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices and methods can be used in conjunction with other devices and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Furthermore, examples may be described with reference to directions indicated as “above,” “below,” “upper,” “lower,” and the like. These terms are used for convenient description, but do not imply any particular spatial orientation unless so indicated.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing aspects from discussed prior art, the numbers are not approximates unless the word “about” is recited. Furthermore, not all alternatives recited herein are equivalents.

A dashed bond (i.e., “- - - ”) as used in certain formulas described herein indicates an “optional” bond to a substituent or atom of the formula other than hydrogen in the sense that the bond (and in some embodiments, the substituent) may or may not be present. In heterocyclic compound formulas provided herein, the dashed bond is used to show where double bonds can be present for certain compounds but need not be in all compounds. The symbol “ [symbol] ” is used to indicate a bond disconnection in abbreviated structures/formulas provided herein.

To facilitate review of the various aspects of the present disclosure, the following explanations of specific terms are provided:

Aliphatic: A substantially hydrocarbon-based compound, or a radical thereof (e.g., C₆H₁₃, for a hexane radical), including alkanes, alkenes, alkynes, including cyclic versions thereof (unless otherwise indicated, such as with the phrase “acyclic aliphatic”), and further including straight-and branched-chain arrangements, and all stereo and position isomers as well. Unless expressly stated otherwise, an aliphatic group contains from one to twenty-five carbon atoms; for example, from one to fifteen, from one to ten, from one to six, or from one to four carbon atoms. An aliphatic chain may be substituted or unsubstituted. Unless expressly referred to as an “unsubstituted aliphatic,” an aliphatic group can either be unsubstituted or substituted. An aliphatic group can be substituted with one or more substituents (up to two substituents for each methylene carbon in an aliphatic chain, or up to one substituent for each carbon of a —C═C— double bond in an aliphatic chain, or up to one substituent for a carbon of a terminal methine group). Exemplary substituents include, but are not limited to, alkyl, alkenyl, alkynyl, alkoxy, alkylamino, alkylthio, acyl, aldehyde, amide, amino, aminoalkyl, aryl, arylalkyl, carboxyl, cyano, cycloalkyl, dialkylamino, halo, haloaliphatic, heteroaliphatic, heteroaryl, heterocycloaliphatic, hydroxyl, oxo, sulfonamide, sulfhydryl, thioalkoxy, or other functionality.

Alcohol: An organic compound comprising at least one hydroxyl group.

Alkyl: A saturated monovalent hydrocarbon having at least one carbon atom to 50 carbon atoms (C₁₋₅₀), such as one to 25 carbon atoms (C₁₋₂₅), or one to ten carbon atoms (C₁₋₁₀), wherein the saturated monovalent hydrocarbon can be derived from removing one hydrogen atom from one carbon atom of a parent compound (e.g., alkane). An alkyl group can be branched, straight-chain, or cyclic (e.g., cycloalkyl) unless indicated otherwise, such as with the phrase “acyclic alkyl.” An alkyl group can be substituted with one or more substituents (up to two substituents for each methylene carbon in an aliphatic chain or up to one substituent for a carbon of a terminal methine group). Exemplary substituents include, but are not limited to, alkyl, alkenyl, alkynyl, alkoxy, alkylamino, alkylthio, acyl, aldehyde, amide, amino, aminoalkyl, aryl, arylalkyl, carboxyl, cyano, cycloalkyl, dialkylamino, halo, haloaliphatic, heteroaliphatic, heteroaryl, heterocycloaliphatic, hydroxyl, oxo, sulfonamide, sulfhydryl, thioalkoxy, or other functionality.

Amine: —NR^{a}R^{b}, wherein each of R^{a} and R^{b} independently is selected from hydrogen, aliphatic, heteroaliphatic, or any combination thereof.

Alkanolamine: an organic compound comprising both an amino group and a hydroxyl group on an alkane backbone.

Capacity: The capacity of a battery is the amount of electrical charge a battery can store (charge capacity) and deliver (discharge capacity). The discharge capacity is typically expressed in units of mAh, or Ah, and indicates the maximum charge a battery can produce over a period of one hour.

Carboxylic Acid: —C(O)OH. An anion of a carboxylic acid group has a formula —C(O)O⁻ wherein the negatively charged oxygen can be balanced with a positively charged ion.

Cell: An electrochemical device used for generating a voltage or current from a chemical reaction, or the reverse in which a chemical reaction is induced by a current. Examples include voltaic cells, electrolytic cells, redox flow cells, and fuel cells, among others. Multiple single cells can form a cell assembly, often termed a stack. A battery includes one or more cells, or even one or more stacks.

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle.

Dihydric: An organic functional group including two hydroxyl groups bound to an aliphatic or heteroaliphatic group.

Electrochemically Active Component: A component (an element, an ion, or a compound) that is capable of forming redox pairs having different oxidation and reduction states, e.g., ionic species with differing oxidation states or a metal cation and its corresponding neutral metal atom. In a flow battery, an electrochemically active component refers to the chemical species that participate in the redox reaction during the charge and discharge processes, contributing to the energy conversions that ultimately enable the battery to deliver/store energy.

Electrolyte: A substance containing free ions and/or radicals that behaves as an ionically conductive medium. In a redox flow battery, some of the free ions and/or radicals are electrochemically active components. An electrolyte in contact with the anode, or negative half-cell, may be referred to as an anolyte, and an electrolyte in contact with the cathode, or positive half-cell, may be referred to as a catholyte. The anolyte and catholyte are often referred to as the negative electrolyte and positive electrolyte, respectively, and these terms can be used interchangeably. As used herein, the terms anolyte and catholyte refer to electrolytes comprising electrochemically active components and an aqueous supporting solution.

Energy efficiency (EE): The product of coulombic efficiency and voltage efficiency and is an indicator of energy loss in charge-discharge processes

Half-cell: An electrochemical cell includes two half-cells. Each half-cell comprises an electrode and an electrolyte. A redox flow battery has a positive half-cell in which electrochemically active components are oxidized, and a negative half-cell in which electrochemically active components are reduced during charge. Opposite reactions happen during discharge.

Heteroaliphatic: An aliphatic group comprising at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group. Exemplary heteroaliphatic groups can include, but are not limited to, alkoxy groups, aliphatic groups terminated with a hydroxyl group, ether groups, polyethyleneimine groups (e.g., —[(CH₂)₂NH]ᵣ— or —[N(H)(CH₂)₂]ᵣ wherein r is an integer selected from at least 1), alkanolamine groups (e.g., —(CH₂)₂N[CH₂C(H)(OH)CH₂OH]₂), and the like. In some aspects of the disclosure, heteroaliphatic can include aliphatic groups terminated with a carboxylic acid group (or an anion thereof) or a sulfonic acid group (or an anion thereof). Heteroaliphatic groups can be cyclic unless otherwise indicated, such as with the phrase “acyclic heteroaliphatic.”

Heteroalkyl: An alkyl group comprising at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group. Exemplary heteroalkyl groups can include, but are not limited to, alkoxy groups, aliphatic groups terminated with a hydroxyl group, ether groups, polyethyleneimine groups (e.g., —[(CH₂)₂NH]ᵣ— or —[N(H)(CH₂)₂]ᵣ wherein r is an integer selected from at least 1), alkanolamine groups (e.g., —(CH₂)₂N[CH₂C(H)(OH)CH₂OH]₂), and the like. In some aspects of the disclosure, heteroalkyl can include alkyl groups terminated with a carboxylic acid group (or an anion thereof) or a sulfonic acid group (or an anion thereof). Heteroalkyl groups can be cyclic unless otherwise indicated, such as with the phrase “acyclic heteroalkyl.”

Monohydric: An organic functional group including one hydroxyl group bound to an aliphatic or heteroaliphatic group.

Polyhydric: An organic functional group including four or more hydroxyl groups bound to an aliphatic or heteroaliphatic group.

Redox Pair or Redox Couple: An electrochemically active component and its corresponding oxidized (or reduced) component.

Sulfonic Acid: —SO₃H. An anion of a sulfonic acid group has a formula —S(O)₂O⁻ wherein the negatively charged oxygen can be balanced with a positively charged ion.

Trihydric: An organic functional group including three hydroxyl groups bound to an aliphatic or heteroaliphatic group.

Voltage efficiency (VE): The voltage produced by the battery while discharging divided by the charging voltage.

### II. Introduction

Redox flow batteries (or RFBs) are energy storage devices that comprise energy storage materials, which are dissolved into a liquid and stored in external tanks. The energy storage materials then flow towards a flow battery stack wherein the electrochemistry and power generation occurs. RFBs are applicable in electric gird storage and have been of interest because they can be tailored to different applications and their duration can be extended by increasing the storage tank size. Furthermore, RFB attributes (e.g., the spatial separation of the reactive materials, the fact that the major constituent is water, the easy thermal management, and/or the ability to easily monitor battery health) can all contribute to the increased safety of such battery systems.

Vanadium redox flow batteries have become increasingly popular; however their sporadic cost and the limited earth-abundance of vanadium limits their widescale implementation. Lower cost systems utilizing zinc, iron, and chromium have been investigated but present their own unique challenges. And, the architecture of all-iron systems that utilize Fe⁰ cannot fully decouple power and capacity. Efforts have been made to utilize the Fe²⁺/Fe³⁺ redox couple at the both the cathode and anode, but such systems have been limited to requiring soluble ligands of small size (e.g., triethanolamine) to alter the reduction potential of iron and require multiple equivalents of additional free ligand in solution to prevent iron oxides from solely precipitating. Due to the large excess of ligands, free ligands that are not bound to an iron center are prone to crossover through the pores of the separation membrane and react with the catholyte, which leads to cell death.

The present disclosure is directed to anolytes comprising unique ligands that address many of the fallbacks discussed above. In particular, the alkanolamine-based ligands disclosed herein provide a suitable reduction potential; reduce the proclivity of membrane crossover; and/or eliminate the need for multiple equivalents of additional free ligand in solution. The alkanolamine-based ligands therefore can be used to provide anolytes for use in RFBs that exhibit increased cell lifetime. Alkanolamine-based ligands disclosed herein comprise at least two substituents that comprise at least two hydroxyl groups. Such substituents facilitate binding an iron atom to each ligand, with many disclosed ligands being capable of binding multiple iron ions per single ligand. As such, anolytes of the present disclosure avoid having to use multiple equivalents of free ligand. The tunable size of the alkanolamine-based ligands disclosed herein also provides an improved level of control over the anolyte composition, which allows using thinner membranes with increased conductivity that are otherwise infeasible in anolyte compositions comprising small amine ligands (e.g., triethanolamine), which are prone to membrane crossover. In certain aspects disclosed herein, the alkanolamine-based ligand is a neutral alkanolamine-based ligand, which further resists membrane crossover by controlling ligand size relative to membrane pore size. Furthermore, the low-cost alkanolamine-based ligands disclosed herein can be used with earth abundant transition metals such as, but not limited to, iron, and yields an anolyte that delivers suitable cell voltages.

### III. Anolyte Composition

Disclosed herein is an anolyte comprising an alkanolamine-based ligand. In aspects disclosed herein, the anolyte further comprises a metal-ion component in addition to the alkanolamine-based ligand. In some aspects, the metal-ion component is selected from the first-row transition metals. In preferable aspects, the metal-ion component comprises an iron ion.

The alkanolamine-based ligand has a structure according to Formula I. In some particular aspects, the alkanolamine is a neutral ligand. In some other aspects, the alkanolamine is a charged ligand.

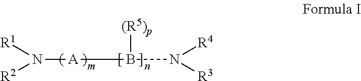

With reference to Formula I, A is selected from acyclic aliphatic or acyclic

heteroaliphatic; each B independently for each occurrence is acyclic aliphatic or acyclic heteroaliphatic; each of R¹, R², R³, and R⁴ independently is selected from hydrogen, aliphatic, or heteroaliphatic; R⁵ is selected from hydroxyl or heteroaliphatic; m is an integer selected from 0 or 1; n is an integer selected from 1 to 500; each p independently for each occurrence is an integer selected from 0 or 1, provided that (i) if B is aliphatic and p is 0, then B is C₃₋₁₀ aliphatic; and (ii) at least two of R¹, R², R³, R⁴, and R⁵ independently comprise a heteroaliphatic group comprising at least two hydroxyl groups. Also with reference to Formula I, the nitrogen atom bearing R³ and R⁴ need not be present as indicated by the dashed bond. In any such aspects, any open valency of any terminal B group is completed with a hydrogen atom.

In some aspects, A is selected from acyclic alkyl or acyclic heteroalkyl, wherein the acyclic alkyl or acyclic heteroalkyl group comprises 1 to 50 carbon atoms. In some aspects, the acyclic alkyl group or the acyclic heteroalkyl group is acyclic lower alkyl or acyclic lower heteroalkyl group having 10 or fewer carbon atoms. In some aspects, the acyclic heteroalkyl group comprises a heteroatom selected from oxygen, sulfur, or nitrogen, with particular aspects comprising nitrogen. In some exemplary aspects, A is selected from CH₂, C₂H₄, or acyclic C₃H₆.

In some aspects, A is selected from acyclic alkyl or acyclic heteroalkyl, wherein the acyclic alkyl or acyclic heteroalkyl group comprises 1 to 50 carbon atoms. In some aspects, the acyclic alkyl group or the acyclic heteroalkyl group is acyclic lower alkyl or acyclic lower heteroalkyl group having 10 or fewer carbon atoms. In some aspects, the acyclic heteroalkyl group comprises a heteroatom selected from oxygen, sulfur, or nitrogen, with particular aspects comprising nitrogen. In some exemplary aspects, B is lower alkyl and is selected from CH₂, C₂H₄, or acyclic C₃H₆. In some other exemplary aspects, B is lower heteroalkyl and is —[N(CH₂)₂]—, wherein each N atom is bound to an R⁵ group if p is 1 or is bound to a hydrogen atom if p is 0.

In some aspects, each of R¹, R², R³, and R⁴ independently is selected from hydrogen, alkyl, or heteroalkyl, wherein the alkyl or heteroalkyl group comprises 1 to 50 carbon atoms. In some aspects, the alkyl group or the heteroalkyl group is lower alkyl or lower heteroalkyl group having 10 or fewer carbon atoms. In some aspects, the heteroalkyl group comprises a heteroatom selected from oxygen, sulfur, or nitrogen, with particular aspects comprising oxygen. In some exemplary aspects, one of R¹, R², R³, and R⁴ is lower alkyl (e.g., methyl, ethyl, propyl, or butyl). In some exemplary aspects, one or more of R¹, R², R³, and R⁴ is a mono-, di-, tri-, or polyhydric group. In representative aspects, one or more of R¹, R², R³, and R⁴ is a dihydroxypropyl group (e.g., —(CH₂)C(H)(OH)CH₂OH); —(CH₂)₂OH; or —(CH₂)[C(H)(OH)]₄CH₂OH.

In some aspects, R⁵ is selected from hydroxyl or heteroalkyl comprising 1 to 50 carbon atoms. In some aspects, the heteroalkyl group is lower heteroalkyl group having 10 or fewer carbon atoms. In some aspects, the heteroalkyl group comprises a heteroatom selected from oxygen, sulfur, or nitrogen, with particular aspects comprising oxygen, nitrogen, or a combination thereof. In some exemplary aspects, R⁵ is —OH or —(CH₂)C(H)(OH)CH₂OH, —(CH₂)₂OH, —(CH₂)[C(H)(OH)]₄CH₂OH, or —(CH₂)₂N[CH₂C(H)(OH)CH₂OH]₂.

In some aspects of the disclosure, A, if present, is selected from CH₂, C₂H₄, or C₃H₆; and each B independently can have a structure according to Formula II, wherein each R⁶ independently for each occurrence is C₂₋₁₀ aliphatic or heteroaliphatic.

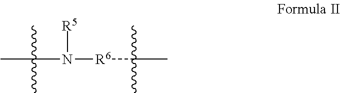

In particular aspects disclosed herein, with reference to Formula II, R⁵ is heteroaliphatic comprising at least one hydroxyl group; and R⁶ is selected from C₂₋₁₀ aliphatic.

In some aspects, at least three of R¹, R², R³, R⁴, and R⁵ independently comprise the heteroaliphatic group comprising at least two hydroxyl groups. In particular aspects, the heteroaliphatic group comprising the at least two hydroxyl groups is a dihydroxypropyl group having a structure —(CH₂)C(H)(OH)CH₂OH. Any R¹, R², R³, R⁴, or R⁵ of Formula I that does not comprise the heteroaliphatic group comprising at least two hydroxyl groups independently is a heteroaliphatic group comprising at least one hydroxyl group.

In some aspects, the alkanolamine-based ligand can further comprise one or more sulfonic acid groups (or an anion thereof) and/or one or more carboxylic acid groups (or an anion thereof). Such aspects, however, further comprise at least two functional groups that are heteroaliphatic and comprise at least two hydroxyl groups. In some such aspects of Formula I, a heteroaliphatic group as defined for R¹, R², R³, or R⁴ can comprise a sulfonic acid group or an anion thereof, or a carboxylic acid group or an anion thereof. In some other such aspects of Formula I, R⁵ can comprise a sulfonic acid group or an anion thereof and/or a carboxylic acid group or an anion thereof. In some aspects, the heteroaliphatic group comprising a sulfonic acid group or an anion thereof and/or a carboxylic acid group or an anion thereof can have a structure according to Formula III.

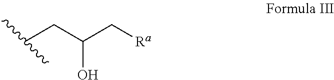

In certain aspects disclosed herein, with reference to Formula III, R^{a} is a sulfonic acid group or an anion thereof, or a carboxylic acid group or an anion thereof.

In particular aspects, the alkanolamine-based ligand has a structure according to Formula IA.

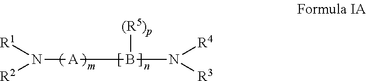

In some aspects disclosed herein, and with reference to Formula IA, n can be 0 and at least three of R¹, R², R³, and R⁴ are —(CH₂)C(H)(OH)CH₂OH. In yet additional aspects, and with reference to Formula I A, m is zero, n is 1, p is 1, B is aliphatic, and R⁵ is OH. In some such aspects, two of R¹, R², R³, and R⁴ independently are —(CH₂)C(H)(OH)CH₂OH or —(CH₂)[C(H)(OH)]₄CH₂OH and any remaining R¹, R², R³, and R⁴ groups are methyl or —(CH₂)₂OH. In yet other aspects, and with reference to Formula IA, at least one R¹, R², R³, R⁴, or R⁵ can have a structure according to Formula III disclosed herein, wherein the Ra group is sulfonic acid or an anion thereof; and n is 1 or 2.

In some aspects disclosed herein, the alkanolamine-based ligand can comprise at least two B groups that are different and thus can have a structure according to Formula IB.

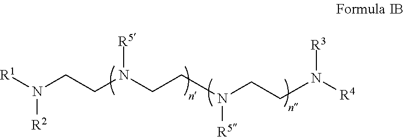

In certain aspects, with refence to Formula IB, each of n′ and n″ independently is an integer selected from 1 to 500, provided that n′+n″=≤500; and wherein each R^{5′} and R^{5″} independently is selected from R⁵ as described herein. In particular aspects, each R^{5′} and R^{5″} independently is selected from hydroxyl or heteroaliphatic.

In some aspects disclosed herein, with reference to Formula I, each heteroaliphatic group is monohydric, dihydric, trihydric, or polyhydric. In some aspects, each of m and p is 1; n is at least 1; and at least two of R¹, R², R³, R⁴, and R⁵ are heteroaliphatic, typically —(CH₂)C(H)(OH)CH₂OH, —(CH₂)[C(H)(OH)]₄CH₂OH, or —(CH₂)₂OH. In certain such aspects, at least two of R¹, R², R³, R⁴, and R⁵ are dihydric.

In aspects disclosed herein, with reference to Formula I, one or more of R¹, R², R³, R⁴, and R⁵ can be heteroaliphatic and selected from:

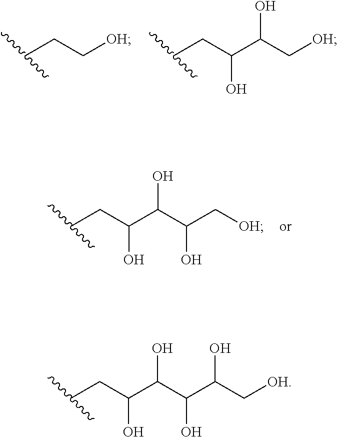

In some such aspects, any R¹, R², R³, R⁴, or R⁵ that does not comprise the heteroaliphatic group comprising the at least two hydroxyl groups is independently heteroaliphatic and is selected from one of the four structures shown above.

In some aspects disclosed herein, with reference to Formula I, B is aliphatic; each of R¹ and R² independently is selected from aliphatic or heteroaliphatic; each R⁵ is OH; m is zero; p is 1; and n is at least 6. In certain aspects, R¹ is aliphatic and R² has a structure according to Formula III shown above. In certain aspects, R^{a} comprises a hydroxyl group, a sulfonic acid group or an anion thereof, or a carboxylic acid group or an anion thereof.

In aspects disclosed herein, the alkanolamine-based ligand can have an average molecular weight ranging from the alkanolamine-based ligand comprises a molecular weight ranging from 100 to 70,000, such as 100 to 60,000, 100 to 55,000, 100 to 50,000, 100 to 45,000, 100 to 40,000, 100 to 35,000, 100 to 30,000, 100 to 25,000, 100 to 20,000, 100 to 15,000, 100 to 10,000, 100 to 5,000, 100 to 2,500, 100 to 2,000, 100 to 1,000, 100 to 950, 100 to 900, 100 to 850, 100 to 800, 100 to 750, 100 to 650, 100 to 600, 100 to 550, 100 to 500, 100 to 450, 100 to 400, 100 to 400, 100 to 350, 100 to 300, 100 to 280, or 100 to 250.

Solely by way of example, the anolyte may comprise an alkanolamine-based ligand selected from the compounds listed below.

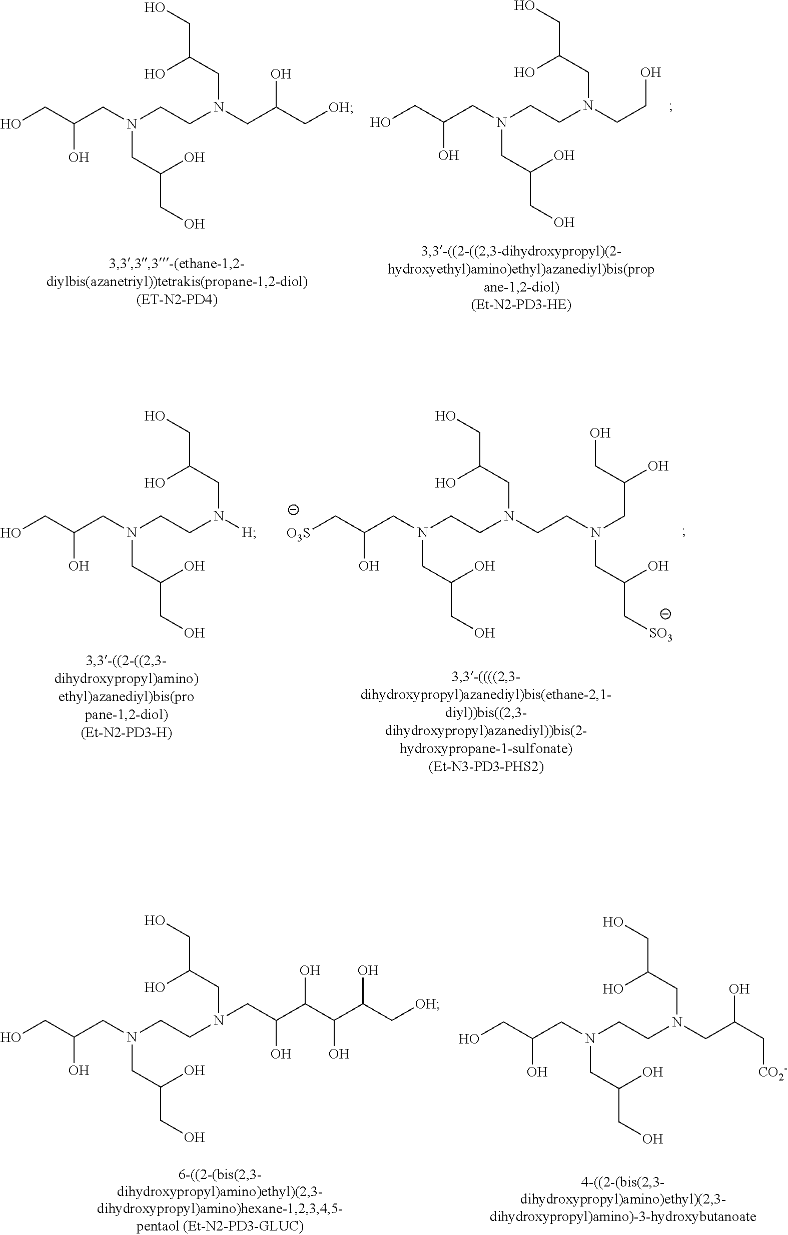

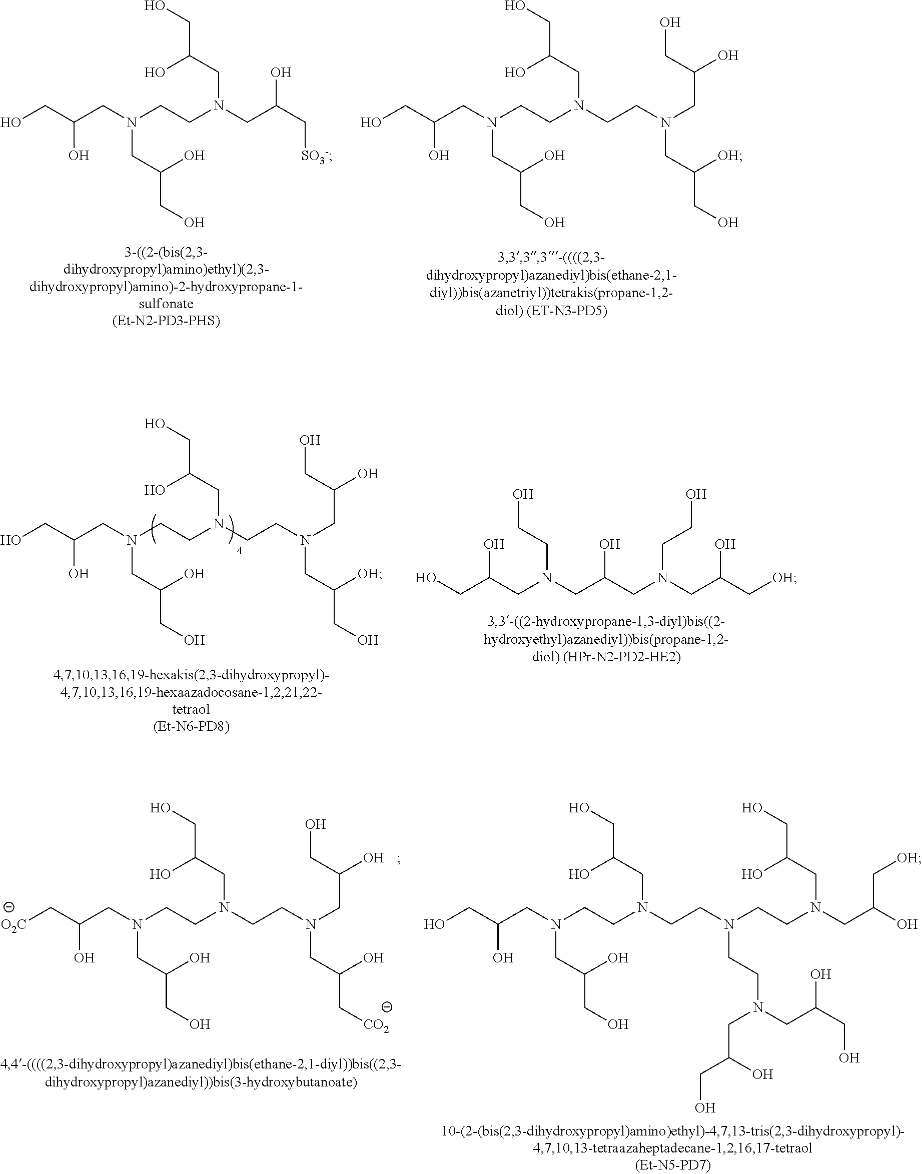

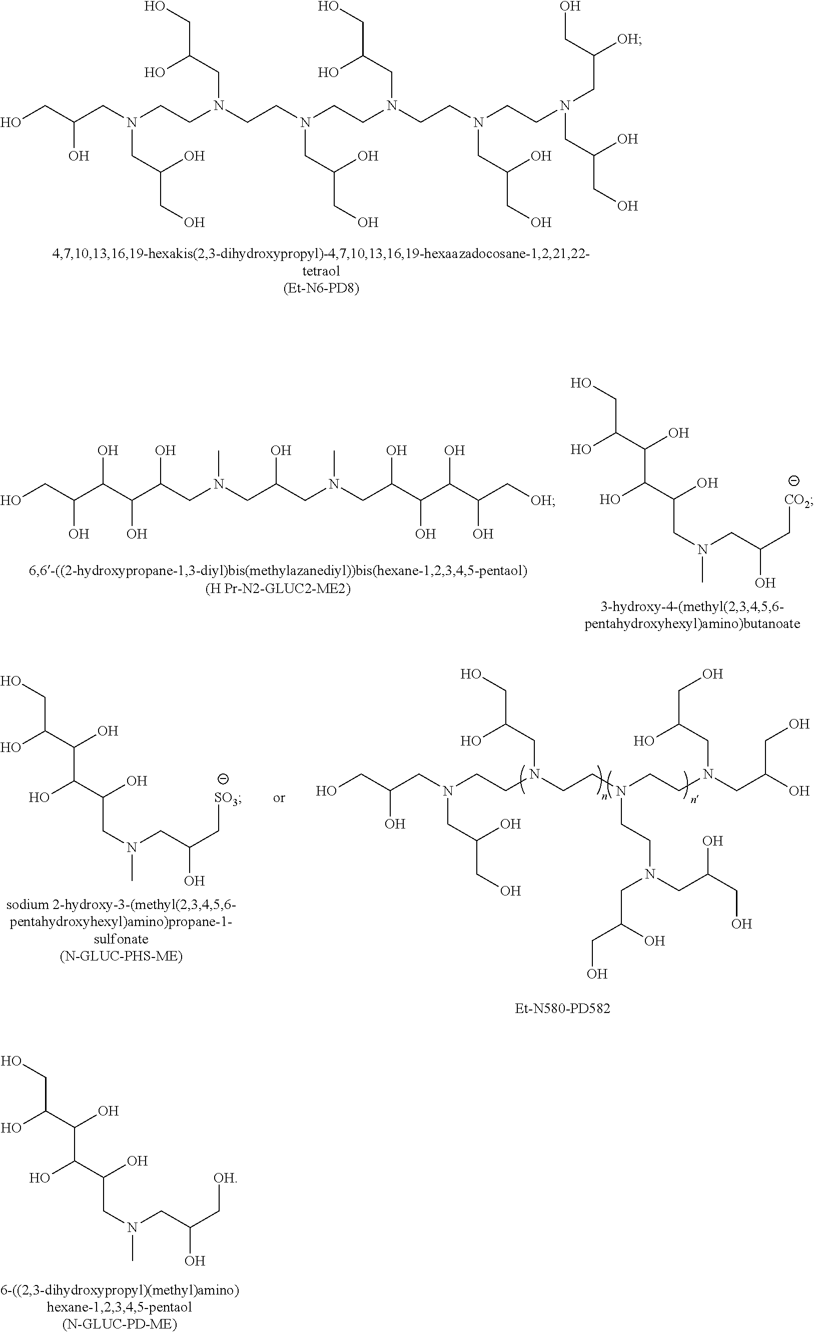

In certain aspects, the alkanolamine is a neutral ligand selected from 3,3′,3″,3″-(ethane-1,2-diylbis(azanetriyl))tetrakis(propane-1,2-diol); 3,3′-((2-((2,3-dihydroxypropyl)(2-hydroxyethyl)amino)ethyl)azanediyl)bis(propane-1,2-diol); dihydroxypropyl)amino)ethyl)azanediyl)bis(propane-1,2-diol); 3,3′-((2-hydroxypropane-1,3-diyl)bis((2-hydroxyethyl)azanediyl))bis(propane-1,2-diol); 6-((2-(bis(2,3-dihydroxypropyl)amino)ethyl)(2,3-dihydroxypropyl)amino)hexane-1,2,3,4,5-pentaol; 3,3′,3″,3′″-((((2,3-dihydroxypropyl)azanediyl)bis(ethane-2,1-diyl))bis(azanetriyl))tetrakis(propane-1,2-diol); 4,7,10,13,16,19-hexakis(2,3-dihydroxypropyl)-4,7,10,13,16,19-hexaazadocosane-1,2,21,22-tetraol; 3,3′-((2-hydroxypropane-1,3-diyl)bis((2-hydroxyethyl)azanediyl))bis(propane-1,2-diol); 10-(2-(bis(2,3-dihydroxypropyl)amino)ethyl)-4,7,13-tris(2,3-dihydroxypropyl)-4,7,10,13-tetraazaheptadecane-1,2,16,17-tetraol; 4,7,10,13,16,19-hexakis(2,3-dihydroxypropyl)-4,7,10,13,16,19-hexaazadocosane-1,2,21,22-tetraol; 6,6′-((2-hydroxypropane-1,3-diyl)bis(methylazanediyl))bis(hexane-1,2,3,4,5-pentaol); or 6-((2,3-dihydroxypropyl)(methyl)amino)hexane-1,2,3,4,5-pentaol.

In other aspects, the alkanolamine may be a charged species selected from sodium 2-hydroxy-3-(methyl(2,3,4,5,6-pentahydroxyhexyl)amino)propane-1-sulfonate; 3-hydroxy-4-(methyl(2,3,4,5,6-pentahydroxyhexyl)amino)butanoate; 4,4′-((((2,3-dihydroxypropyl)azanediyl)bis(ethane-2,1-diyl))bis((2,3-dihydroxypropyl)azanediyl))bis(3-hydroxybutanoate); 3,3′-((((2,3-dihydroxypropyl)azanediyl)bis(ethane-2,1-diyl))bis((2,3-dihydroxypropyl)azanediyl))bis(2-hydroxypropane-1-sulfonate); 3-((2-(bis(2,3-dihydroxypropyl)amino)ethyl)(2,3-dihydroxypropyl)amino)-2-hydroxypropane-1-sulfonate; or 4-((2-(bis(2,3-dihydroxypropyl)amino)ethyl)(2,3-dihydroxypropyl)amino)-3-hydroxybutanoate.

The alkanolamine-based ligands according to the present disclosure can be prepared by reacting one or more amine-containing compounds with one or more epoxides or one or more organohalides. In some aspects, the amine-containing compound can be a monoamine, a diamine, or a polyamine.

In particular aspects, the monoamine can have a structure according to a formula H(R)N-(A)ₘ[B(R⁵)ₚ]ₙ, wherein R is H or aliphatic; A is acyclic aliphatic or acyclic heteroaliphatic; each B independently for each occurrence is acyclic aliphatic; R⁵, if present, is selected from hydroxyl or heteroaliphatic; m is an integer selected from 0 or 1; each p independently for each occurrence is an integer selected from 0 or 1; and n is selected from 1 to 500.

In particular aspects, the diamine can have a structure according to a formula H(R)N-(A)ₘ[B(R⁵)ₚ]ₙ-N(R)H, wherein each R independently is H or aliphatic; A is acyclic aliphatic or acyclic heteroaliphatic; each B independently for each occurrence is acyclic aliphatic; R⁵, if present, is OH; m is an integer selected from 0 or 1; each p independently for each occurrence is an integer selected from 0 or 1; and n is selected from 1 to 500.

In particular aspects, the polyamine can have a structure according to a formula H(R)N-(A)ₘ[B(R⁵)ₚ]ₙ—N(R)H, wherein each R independently is H or aliphatic; A is acyclic aliphatic or acyclic heteroaliphatic; each B independently for each occurrence is acyclic heteroaliphatic (particularly —[N(CH₂)₂]— wherein the nitrogen atom is bound to R⁵ or H); R⁵, if present, is OH or heteroaliphatic; m is an integer selected from 0 or 1; each p independently for each occurrence is an integer selected from 0 or 1; and n is selected from 1 to 500. In certain aspects, B is selected from ethylenediamine; diethylenetriamine; triethylenetetramine; tetraethylenepentamine; pentaethylenehexamine; hexaethyleneheptamine; linear, branched, or dendritic polyethyleneimine (PEI), or the like. In some aspects, the one or more polyamines can have an average molecular weight (M_{w}) ranging from 450 to 25,000.

In some aspects, the one or more epoxides can have a structure according to Formula IV.

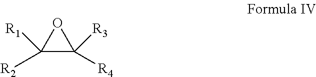

In certain aspects, with reference to Formula IV, R¹-R⁴ independently are hydrogen, aliphatic, heteroaliphatic, or haloaliphatic.

In some aspects, the one or more organohalides comprise (i) an organic portion comprising one or more aliphatic and/or heteroaliphatic groups and (ii) a terminal halide atom that can be displaced by the amine-containing compound such that the amine-containing compound can be coupled to the organic portion.

In particular aspects disclosed herein, the alkanolamine-based ligands disclosed herein can be made according to the method illustrated in Scheme 1, with exemplary aspects being made according to the method of Scheme 1A.

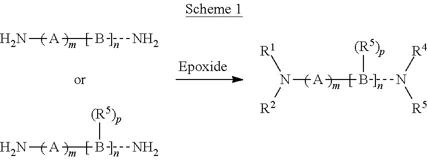

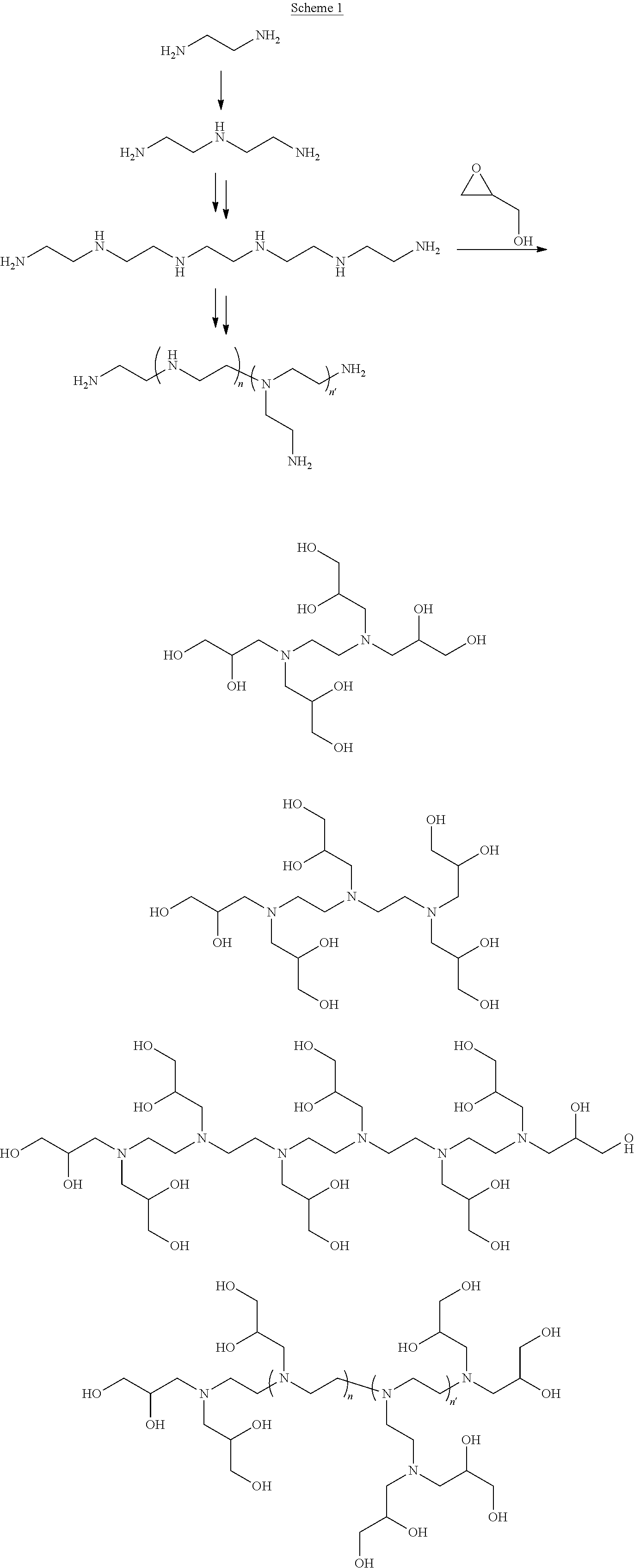

### IV. System

Also disclosed herein is a redox flow battery system that can provide electrical energy converted from chemical energy continuously for use in energy storage applications and provides flexibility and resiliency to the power grid. In aspects disclosed herein, the redox flow battery system comprises a catholyte; an anolyte comprising the alkanolamine-based ligand disclosed herein and a metal-ion component (preferably an iron-ion component); and an ion selective membrane disposed between the catholyte and anolyte. In aspects disclosed herein, the redox flow battery system is based on aqueous iron/iron electrochemistry. In certain aspects, the anolyte and catholyte are based upon the Fe²⁺/Fe³⁺ redox couple.

In aspects disclosed herein, the anolyte comprises the alkanolamine-based ligand and the iron-ion component disclosed herein present in amounts that provide a ratio of alkanolamine-based ligand:iron-ion component ranging from 1:125 to 2:1, such as 1:100, 1:75; 1:50, 1:25, 1:10, 1:5, 1:4, 1:3, 1:2, 1:1, 1.25:1, 1.5:1, and 1.75:1. In exemplary aspects, the ratio is 1:1. In certain aspects the anolyte is prepared by mixing an iron-ion component such as an iron salt (e.g., FeCl₃), with an aqueous solution comprising the alkanolamine-based ligand.

In some aspects, the anolyte has a pH ranging from 8-14, preferably from 10-14, and more preferably from 11-14. In certain aspects, the anolyte can further comprise a base for reaching a suitable pH such as, but not limited to, sodium hydroxide, potassium hydroxide, or a combination thereof.

In some aspects, the anolyte and catholyte are separated by a membrane or separator, such as an ion selective membrane (cation-or anion-exchange membrane), ion conductive membrane (polymer or ceramic) or porous separator. In certain aspects, the ion selective membrane comprises a proton selective membrane, such as, but not limited to, a perfluorosulfonic acid membrane (e.g., Nafion® membranes like N115, NR-212, and NR-211 membranes, available from Ion Power, Inc., New Castle, DE). In certain aspects, the ion selective membrane comprises a non-fluorinated membrane, such as, but not limited to, a sulfonated polyaryletherketone-copolymer membrane (e.g., FUMASEP® E-620(K)). In some aspects, the alkanolamine ligand is designed to have a molecular weight (or size) that prevents entry of the ligand (or any iron-complexed ligand) from passing through pores in the membrane. In certain aspects, the alkanolamine ligand is designed to have a molecular weight (or size) sufficiently large enough to avoid passing through pores of an ion selective membrane, wherein the average pore size ranging from 1 nm to 250 nm, such as from 1 nm to 225 nm, 1 nm to 200 nm, 1 nm to 175 nm, 1 nm to 150 nm, 1 nm to 125 nm, 1 nm to 100 nm, 1 nm to 75 nm, 1 nm to 50 nm, or 1 nm to 25 nm.

In aspects disclosed herein, the catholyte comprises an electrochemically active material suitable for use in an RFB, water, and/or a base. In certain embodiments, the base is the same base as that of the anolyte and may have the same concentration as the base in the anolyte. In some aspects, the electrochemically active material in the catholyte is an aqueous solution comprising ferricyanide and/or a salt thereof. In certain aspects, the catholyte comprises sodium ferrocyanide, potassium ferrocyanide, ammonium ferrocyanide, or any combination thereof.

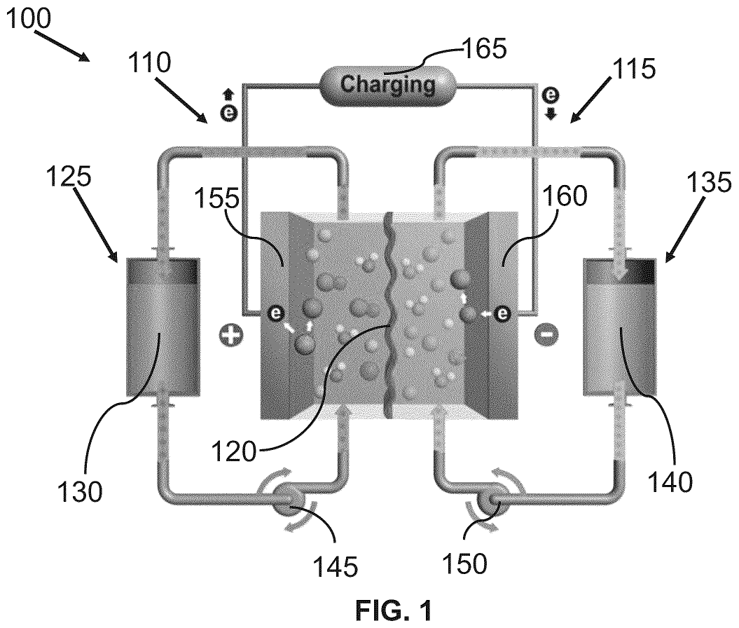

As shown in FIG. 1, some aspects of an aqueous redox flow battery system 100 comprise a positive half-cell 110 and negative half-cell 115. The half cells are separated by a membrane or separator 120, such as an ion selective membrane. The positive half-cell 110 comprises an electrode tank 125 containing a catholyte 130 and the negative half-cell 115 comprises an electrode tank 135 containing an anolyte 140. The anolyte and catholyte are solutions comprising electrochemically active components in different oxidation states, wherein the anolyte comprises an alkanolamine-based ligand according to the present disclosure. The electrochemically active components in the catholyte and anolyte couple as redox pairs. In some embodiments, at least one of the catholyte and anolyte redox active materials remains fully soluble during the charging and discharging cycles of the redox flow battery. The catholyte and anolyte are continuously circulating via pumps 145, 150 through the positive and negative electrodes 155, 160. The electrodes are selected to be stable with the anolyte and catholyte. In some embodiments, the electrodes are carbon-based. Suitable carbon-based materials include, but are not limited to, carbon felt, carbon paper, and woven carbon cloth.

When charging, as illustrated in FIG. 1, the current flows from catholyte 130 to the anolyte 140 such that the metal-ion in the catholyte 130 loses an electron and the metal-ion in the anolyte 140 gains an electron. When discharging, the current flows from the anolyte 140 to the catholyte 130, wherein the metal-ion of the anolyte 140 loses an electron and the metal-ion of the catholyte 130 gains an electron. During charging and discharging, the catholyte and anolyte are continuously circulating via pumps 145, 150 through the positive and negative electrodes 155, 160, respectively, where redox reactions proceed, providing the conversion between chemical energy and electrical energy or vice-versa. To complete the circuit during use, positive and negative electrodes (including a current collector at each side) 155, 160 of the redox flow battery system 100 are electrically connected through current collectors (not shown) with an external load 165.

### V. Method of Using

Also disclosed herein is a method of using an anolyte, comprising placing the anolyte disclosed herein in a redox flow battery system cell comprising a catholyte and an ion selective membrane; and producing an open circuit voltage ranging from 0.5 V to 2.0 V.

In aspects disclosed herein, redox flow battery systems using the anolyte disclosed herein exhibit stable performance characteristics over repeated charge/discharge cycles such that the performance characteristics do not substantially change over repeated cycling of the battery system. In some aspects, the current and voltage vary by less than 10% over at least 5 cycles, at least 10 cycles, or at least 15 cycles. The current and voltage characteristics may remain substantially the same over at least 10,000 seconds, at least 50,000 seconds, at least 100,000 seconds, or at least 150,000 seconds.

In some aspects, redox flow battery systems using the anolyte disclosed herein may exhibit a coulombic efficiency from 70-100%, with the coulombic efficiency varying by less than 10% over at least 10 cycles, at least 20 cycles, at least 40 cycles, at least 50 cycles, at least 75 cycles, or even at least 100 cycles. Certain aspects have a voltage efficiency and an energy efficiency of at least 50%, such as from 50% to 90%, over at least 10 cycles, at least 20 cycles, at least 40 cycles, at least 50 cycles, at least 75 cycles, or even at least 100 cycles.

Methods of using the anolyte disclosed herein provide superior efficiency without the disadvantages of existing redox flow battery systems.

### VI. Overview of Several Aspects

Disclosed herein are aspects of an anolyte, comprising an iron-ion component and an alkanolamine-based ligand having a structure according to Formula I,

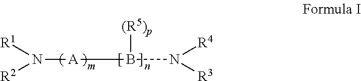

wherein: A is selected from acyclic aliphatic or acyclic heteroaliphatic; each B independently for each occurrence is acyclic aliphatic or acyclic heteroaliphatic; each of R¹, R², R³, and R⁴ independently is selected from hydrogen, aliphatic, or heteroaliphatic; R⁵ is selected from hydroxyl or heteroaliphatic; m is an integer selected from 0 or 1; n is an integer selected from 1 to 500; and each p independently for each occurrence is an integer selected from 0 or 1; provided that (i) if B is aliphatic and p is 0, then B is C₃₋₁₀ aliphatic; and (ii) at least two of R¹, R², R³, R⁴, and R⁵ independently comprise a heteroaliphatic group comprising at least two hydroxyl groups.

In some aspects of the disclosure, A is present and is selected from CH₂, C₂H₄, or C₃H₆; and each B independently has a structure according to Formula II,

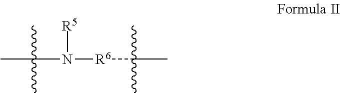

wherein: R⁵ is heteroaliphatic comprising at least one hydroxyl group; and R⁶ is selected from C₂₋₁₀ aliphatic or heteroaliphatic.

In any or all of the above aspects, any R¹, R², R³, R⁴, or R⁵ that does not comprise the heteroaliphatic group comprising at least two hydroxyl groups independently is a heteroaliphatic group comprising at least one hydroxyl group.

In any or all of the above aspects, at least three of R¹, R², R³, R⁴, and R⁵ independently comprise the heteroaliphatic group comprising at least two hydroxyl groups.

In any or all of the above aspects, the heteroaliphatic group comprising the at least two hydroxyl groups is a dihydroxypropyl group having a structure —(CH₂)C(H)(OH)CH₂OH.

In any or all of the above aspects, the alkanolamine-based ligand has a structure according to Formula IA,

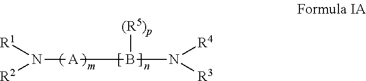

wherein n is 0 and at least three of R¹, R², R³, and R⁴ are —(CH₂)C(H)(OH)CH₂OH.

In any or all of the above aspects, the alkanolamine-based ligand has a structure according to Formula IA,

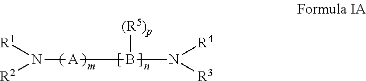

wherein m is zero, n is 1, p is 1, B is aliphatic, and R⁵ is OH.

In any or all of the above aspects, two of R¹, R², R³, and R⁴ independently are the heteroaliphatic group comprising the at least two hydroxyl groups and are selected from —(CH₂)C(H)(OH)CH₂OH or —(CH₂)[C(H)(OH)]₄CH₂OH and any remaining R¹, R², R³, or R⁴ groups are methyl or —(CH₂)₂OH.

In any or all of the above aspects, the alkanolamine-based ligand comprises at least two B groups that are different and has a structure according to Formula IB,

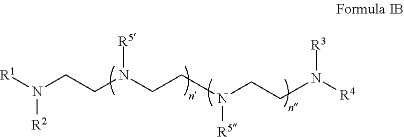

wherein: each of n′ and n″ independently is an integer selected from 1 to 500, provided that n′ +n″=≤500; and wherein each R^{5′} and R^{5″} independently is selected from hydroxyl or heteroaliphatic.

In any or all of the above aspects, each of m and p is 1; n is at least 2; and each R⁵ is —(CH₂)C(H)(OH)CH₂OH.

In any or all of the above aspects, any R¹, R², R³, R⁴, or R⁵ that does not comprise the heteroaliphatic group comprising at least two hydroxyl groups independently is heteroaliphatic and is selected from:

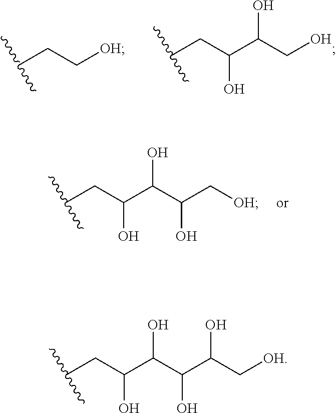

In any or all of the above aspects, the alkanolamine-based ligand is selected from:

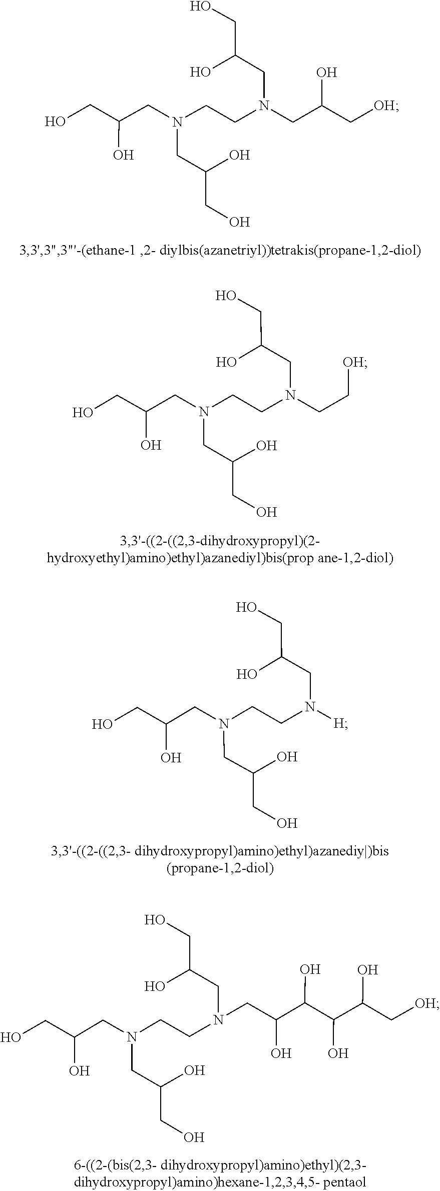

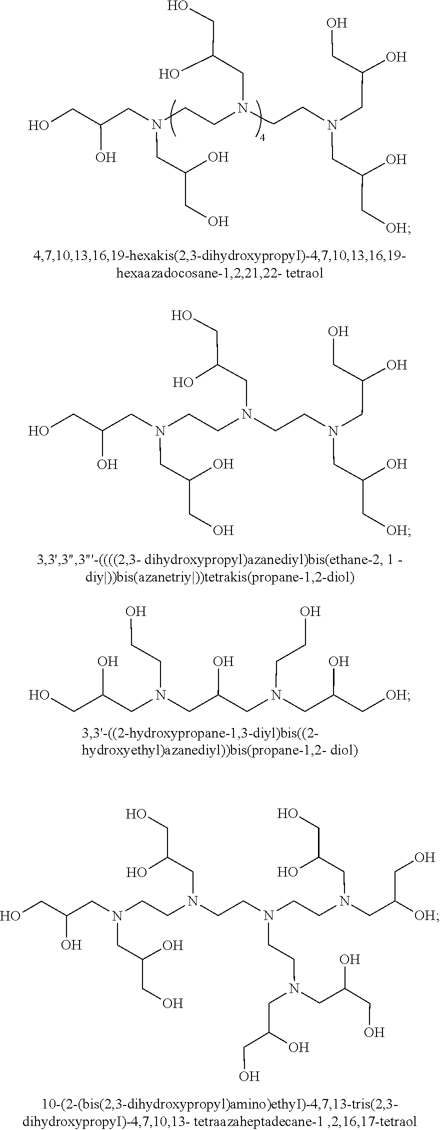

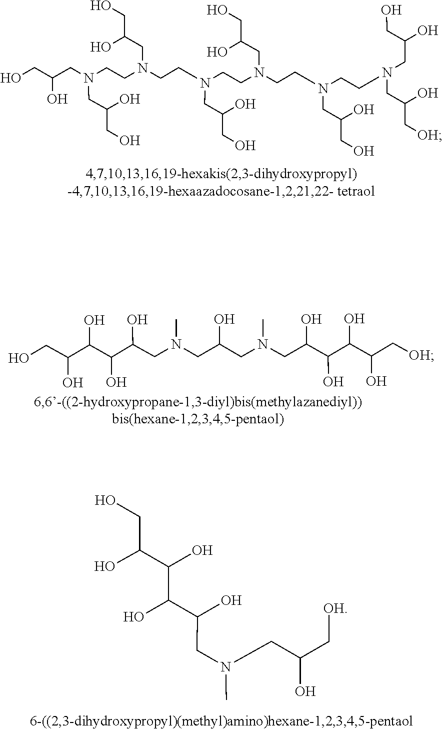 [SMILES: OCC(O)CN(CCN(CCN(CCN(CC(O)CO)CC(O)CO)CC(O)CO)CC(O)CO)CCN(CCN(CC(O)CO)CC(O)CO)CC(O)CO ; CN(CC(O)CN(C)CC(O)C(O)C(O)C(O)CO)CC(O)C(O)C(O)C(O)CO ; CN(CC(O)CO)CC(O)C(O)C(O)C(O)CO]

In any or all of the above aspects, at least one of R¹, R², R³, R⁴, or R⁵ has a structure according to Formula III,

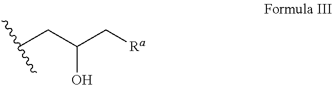

wherein R^{a} comprises a sulfonic acid group or an anion thereof; or a carboxylic acid group or an anion thereof.

In any or all of the above aspects, the alkanolamine-based ligand has a structure according to Formula IA,

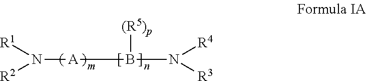

wherein the at least one R¹, R², R³, R⁴, or R⁵ having a structure according to Formula III comprises an R^{a} group that is a sulfonic acid or an anion thereof; and n is 1 or 2.

In any or all of the above aspects, the alkanolamine-based ligand is selected from:

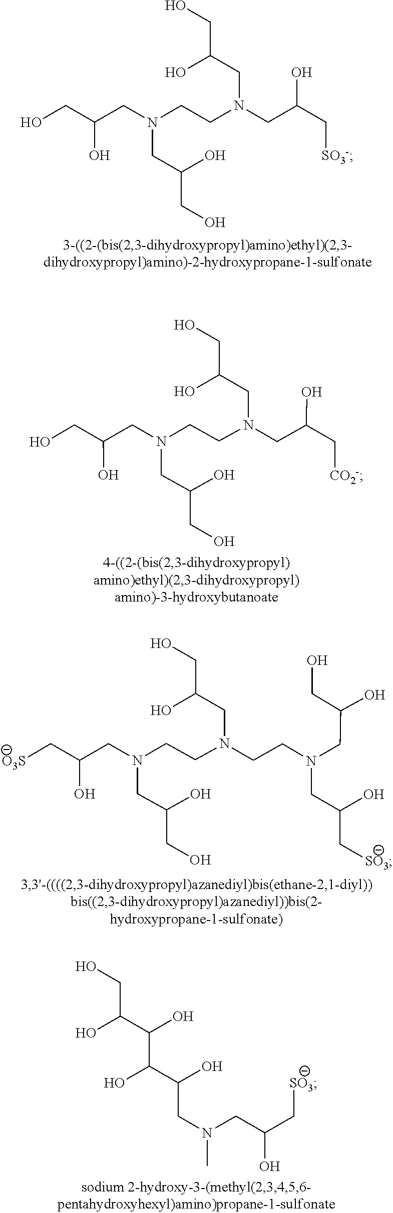

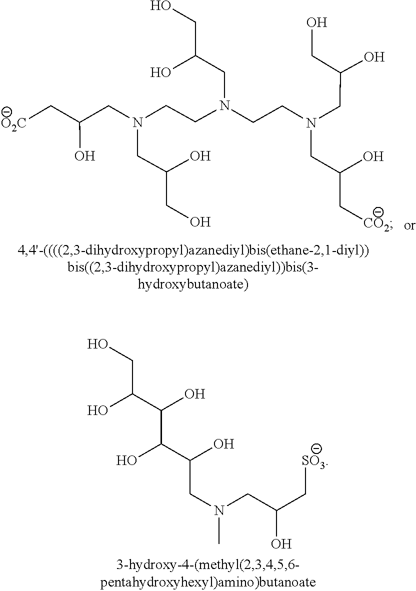

In any or all of the above aspects, the alkanolamine-based ligand is coordinated with a plurality of iron-ion components.

A redox flow battery system is also disclosed herein, the redox flow battery system comprising the anolyte disclosed herein; a catholyte; and an ion selective membrane disposed between the catholyte and anolyte.

In any or all of the above aspects, the alkanolamine-based ligand comprises a molecular weight ranging from 150 to 70,000.

In any or all of the above aspects, the ion selective membrane comprises a pore size ranging from 1 nm to 250 nm.

In any or all of the above aspects, the alkanolamine-based ligand and the iron-ion component of the anolyte are present in amounts providing a ratio of 1:1 alkanolamine-based ligand:iron-ion component.

In any or all of the above aspects, the catholyte comprises ferrocyanide.

Also disclosed herein is a method, comprising placing the anolyte disclosed herein in a redox flow battery system cell comprising a catholyte and an ion selective membrane; and producing an open circuit voltage ranging from 0.5 V to 2.0 V.

### VII. Examples

Ligand Preparation: Ligands were prepared from commercially available reagents and used as received. Reaction were carried out under a nitrogen atmosphere and monitored by ¹H-NMR until completion. The use of racemic precursors results in multiple ligand isomers for a given ligand and resultingly complex, overlapping resonances in NMR spectra. Representative syntheses are provided, and analogous methods are used to produce higher/lower oligomer sizes. For simplicity, the ligands are named according to A-B-Cn, where A is the linker group connecting nitrogen centers, B is the number of nitrogen centers, C are the functional groups attached to the nitrogen centers, and n is the number of said functional groups in the ligand. For examples provided below; for A, Et=ethyl, HPr=2-hydroxypropyl. For B, N2 refers to ligands with two nitrogen centers, N3 refers to ligands with three nitrogen centers, etc. For C,

PD=propanediol (derived, for instance, from glycidol), PHS=hydroxypropanesulfonic acid sodium (derived, for instance, from 3-chloro-2-hydroxypropanesulfonic acid sodium), HE=2-hydroxyethane, GLUC refers to the hydroxylated group derived from N-methyl-D-glucamine.

Et-N2-PD4: Ethylene diamine (3.0 g., 50 mmol) was dissolved in 50 ml of water and chilled on an ice bath. Glycidol (14.86 g., 200.6 mmol) was added dropwise and the ice bath allowed to melt overnight. The reaction was monitored by ¹H-NMR and upon completion the mixture was pre-concentrated by evaporation under a flow of nitrogen to yield more concentrated solutions and then used as-is for electrolyte preparation. ¹H NMR (D₂O, 400 MHZ): δ 3.83; (m, 4H), 3.61-3.47; (m, 8H), 2.79-2.54; (m, 12H). Note: the use of racemic glycidol results in multiple species and overlapping resonances.

Et-N3-PD3-PHS2: Diethylenetriamine (1.03 g., 10 mmol) was dissolved in 10 mL of water and chilled on an ice bath. An ˜16 mL aqueous solution of 3-chloro-2-hydroxypropanesulfonic acid sodium (3.93 g., 20 mmol) was added to the amine. After stirring ˜45 minutes, a 6 mL solution of sodium hydroxide (0.85 g., 21.2 mmol) was added dropwise. The reaction was stirred two days and the ice bath allowed to melt. The reaction was then re-chilled on an ice bath and glycidol (2.98 g., 40.2 mmol) was added dropwise. The ice bath was allowed to melt and the reaction was monitored by ¹H-NMR until completion. ¹H NMR (D₂O, 400 MHZ): δ 4.22; (br, 2H), 3.87; (br, 3H), 3.66-3.52; (m, 6H), 3.15-3.00; (m, 4H), 2.78-2.59; (m, 18H). Note: complex spectrum from mixed isomers and use of racemic precursors.

HPr-N2-GLUC2-Me2: N-methyl-D-glucamine (3.90 g., 20 mmol) was stirred in 20 mL of water and chilled on an ice bath. Epichlorohydrin (0.929 g., 10 mmol) was added dropwise. The reaction stirred overnight and ice bath allowed to melt. The reaction was then set to 80° C. overnight, after which the temperature was increased to 105° C. and held there for two days. After cooling to room temperature, one equivalent of sodium hydroxide was added and the final solution was concentrated under a flow of nitrogen and then used directly for electrolyte preparation. 1H NMR (D₂O, 400 MHz): δ 4.02-3.63; (m, 13H), 2.69-2.51; (m, 8H), 2.35; (s, 3H), 2.33; (s, 3H).

HPr-N2-PD2-HE2: Ethanolamine (24.25 g., 397 mmol) was weighed and placed in a 100 mL round bottomed flask equipped with a reflux condenser, and then 1,3-dichloro-2-propanol (6.45 g., 50 mmol) was slowly added over a period of 1 hr. The solution was refluxed at 80° C. for two days and then cooled to room temperature. A solution of potassium hydroxide (5.61 g., 100 mmol) in 40 mL of ethanol was added to the mixture and the resulting precipitate was filtered away. Chloroform was added to the filtrate and the resulting precipitate filtered and dried under vacuum to obtain the intermediate 1,3-bis(2-hydroxyethylamino)-2-hydroxypropane (3.35 g., 18.8 mmol, 38%). This intermediate (0.892 g., 5.0 mmol) was dissolved in 10 mL of water and cooled on an ice bath. Glycidol (0.750 g., 10 mmol) was added slowly and the mixture was allowed to stir overnight and the ice bath allowed to melt. After two days, the reaction was set to 50° C. and stirred overnight at the temperature. The resulting solution was used directly for the preparation of electrolyte. 1H NMR (D2O, 400 MHZ): δ 3.91-3.84; (br, 3H), 3.69-3.49; (m, 8H), 2.83-2.52; (m, 12H).

Et-N580-PD582: Polyethyleneimine (MW 25,000) (3.62 g., ˜0.145 mmol) was dissolved in 35 mL of methanol. Glycidol (6.23 g., 84.1 mmol) was added dropwise and the reaction was stirred for 3 days. The reaction was then refluxed overnight to completion. The methanol was removed and the gel was triturated with water multiple times to remove residual methanol, then dissolved into water and used as-is in subsequent electrolyte preparations. ¹H NMR (D₂O, 400 MHz): δ 3.86; (br, 1H), 3.63-3.54; (br, 2H), 2.72-2.60; (br, 6H). Approximate number of nitrogens and functional groups (580 & 582, respectively) is derived by dividing the molecular weight of the polyethyleneimine (25,000) by the repeat polymer unit weight (˜43.06), though the actual polymers in solution will have a distribution of sizes dictated by the polyethyleneimine precursor.

Electrolyte Preparation: Electrolytes were prepared in a nitrogen purged containment box and all base solutions used for deprotonation were also prepared and stored in the nitrogen box. Electrolytes were prepared following the same procedure of adding a premade aqueous solution of FeCl₃ to a stirring, aqueous solution of ligand, and then adding base from stock 10M solution of KOH or NaOH until reaching the desired pH or hydroxide equivalents. Example preparations are described below. Flow cell tests were performed within the nitrogen purged box using house-made interdigitated cells of 10 cm² active area and 3 layers of heat treated ELAT as electrodes. Nafion® 212 membranes were soaked in either KOH or NaOH at room temperature before use. Electrolyte was flowed through the cells using peristaltic pumps at a rate of 40 mL/min and cells were cycled at 20 mA/cm², unless otherwise noted.

### Example 1

In this example, a redox flow battery system using an anolyte comprising an iron-ion component and Et-N2-PD4 was investigated. The Fe(Et-N2-PD4) was prepared by treating a 5 mmol solution of Et-N2-PD4 in water with a 5 mmol solution of FeCl₃ in water with stirring. The mixture was treated with 3.5 equivalents of KOH from a stock 10M solution to yield a solution of pH12 and a final volume of 12 mL. A catholyte of 10 mL volume was prepared with 0.5M ferrocyanide (from equal parts sodium and potassium precursors), 0.2M potassium ferricyanide, and then dropwise addition of stock 10M KOH until a pH of 13 was reached.

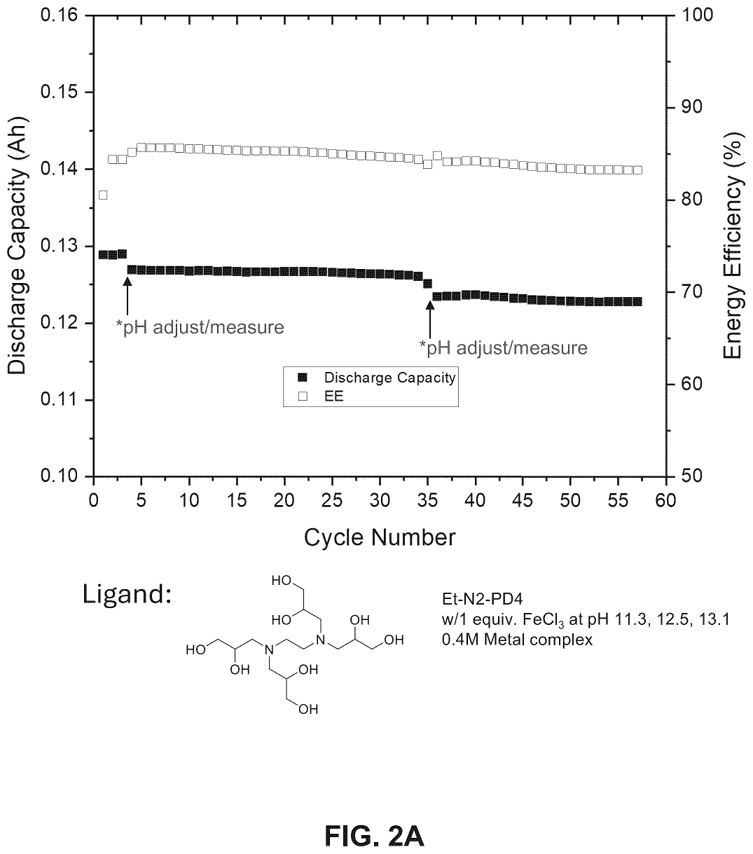

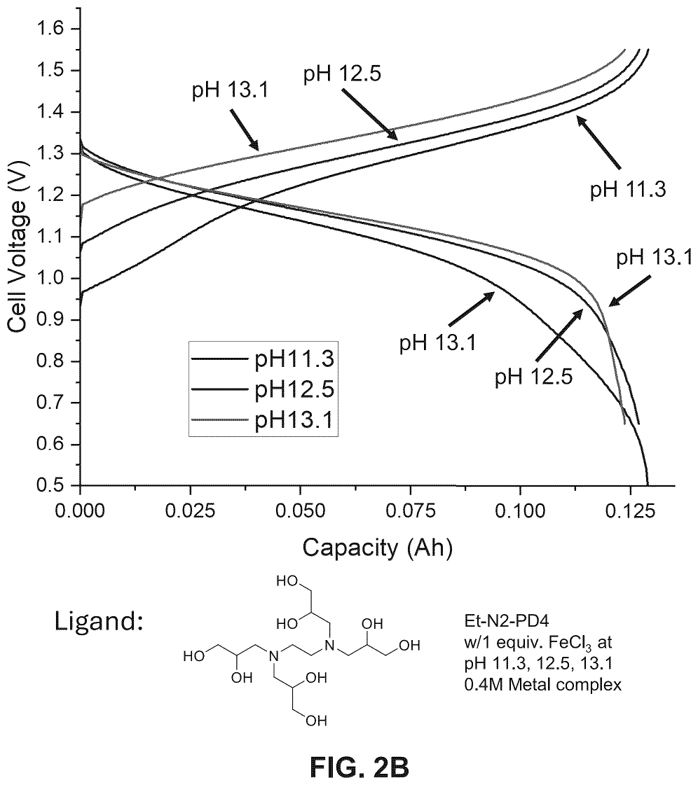

The electrolytes were flowed through an assembled cell and the pH of the anolyte was then measured at 11.3. The cell was briefly cycled, then paused and the anolyte was basified with KOH until pH 12.5. The cell was briefly cycled, then paused and the anolyte was basified with KOH until pH 13.1. Cell cycling was then resumed, yielding cycling data provided in FIGS. 2A and 2B. FIG. 2A is a graph showing the discharge capacity and energy efficiency over repeated cycling and FIG. 2B is a graph showing the charge and discharge profiles at pH 11.3, 12.5, and 13.

The redox flow battery system achieved a stable discharge capacity an energy efficiency (EE) greater than 80% after each pH adjustment/measurement, and the cell provided stable cycling at 20 mA/cm² over 55 cycles. Therefore, this example demonstrates that the redox flow battery system using an anolyte comprising Et-N2-PD4 supported Fe(III) ions at pH 11.3, 12.5, and 13.

### Example 2

In this example, a redox flow battery system using an anolyte comprising an iron-ion component and Et-N2-PD4 was investigated at pH 14. The Fe(Et-N2-PD4) was prepared by treating a 5 mmol solution of Et-N3-PD5 in water with a 5 mmol solution of FeCl₃ in water with stirring. The mixture was treated with 3 equivalents of KOH from a stock 10M and 3 equivalents of NaOH from a stock 10M solution to yield a solution of pH14 and a final volume of 10 mL. A catholyte of 12 mL volume was prepared with 0.5M ferrocyanide (from equal parts sodium and potassium precursors), 0.1M potassium ferricyanide, and then 1M hydroxide from equal parts KOH/NaOH.

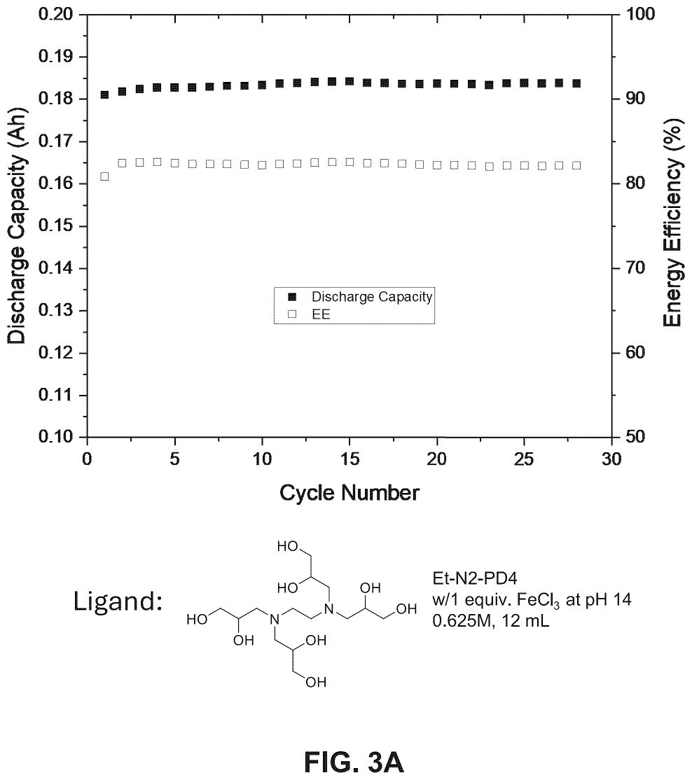

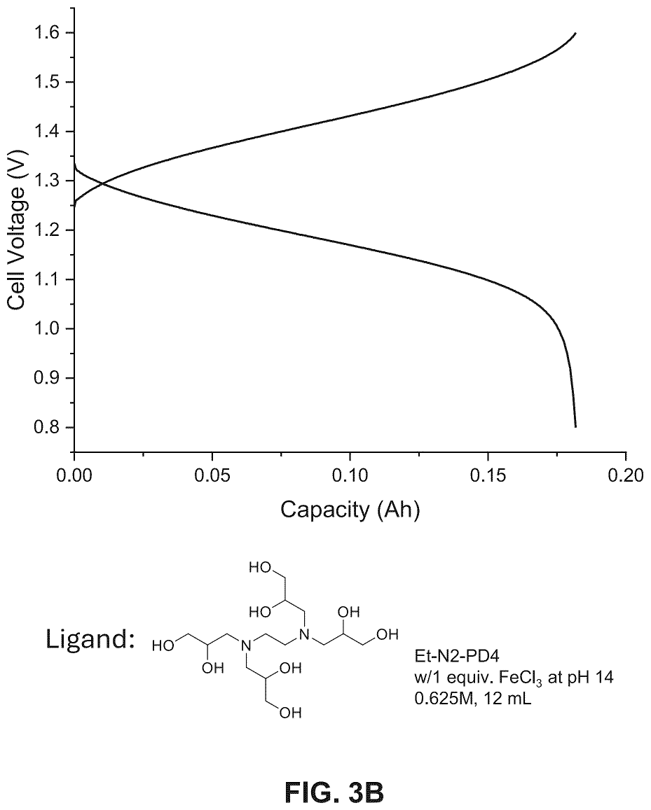

The electrolytes were flowed through an assembled cell and cycled at 20 mA/cm² yielding data provided in FIGS. 3A and 3B. FIG. 3A is a graph showing the discharge capacity and energy efficiency over repeated cycling. FIG. 3B is a graph showing the charge and discharge profiles at pH 14.

The redox flow battery system demonstrated a stable discharge capacity an EE greater than 80%, and the cell provided stable cycling at 20 mA/cm2 over 25 cycles. Therefore, this example demonstrates that the redox flow battery system using an anolyte comprising Et-N2-PD4 supported Fe(III) ions up to pH 14.

### Example 3

In this example, a redox flow battery system using an anolyte comprising an iron-ion component and Et-N3-PD5 was investigated. Fe(Et-N3-PD5) was prepared by treating a 5 mmol solution of Et-N3-PD5 in water was treated with a 5 mmol solution of FeCl₃ in water with stirring. The mixture was treated with 3 equivalents of KOH from a stock 10M and 3 equivalents of NaOH from a stock 10M solution to yield a solution of pH14 and a final volume of 10 mL. A catholyte of 12 mL volume was prepared with 0.5M ferrocyanide (from equal parts sodium and potassium precursors), 0.1M potassium ferricyanide, and then 1M hydroxide from equal parts KOH/NaOH.

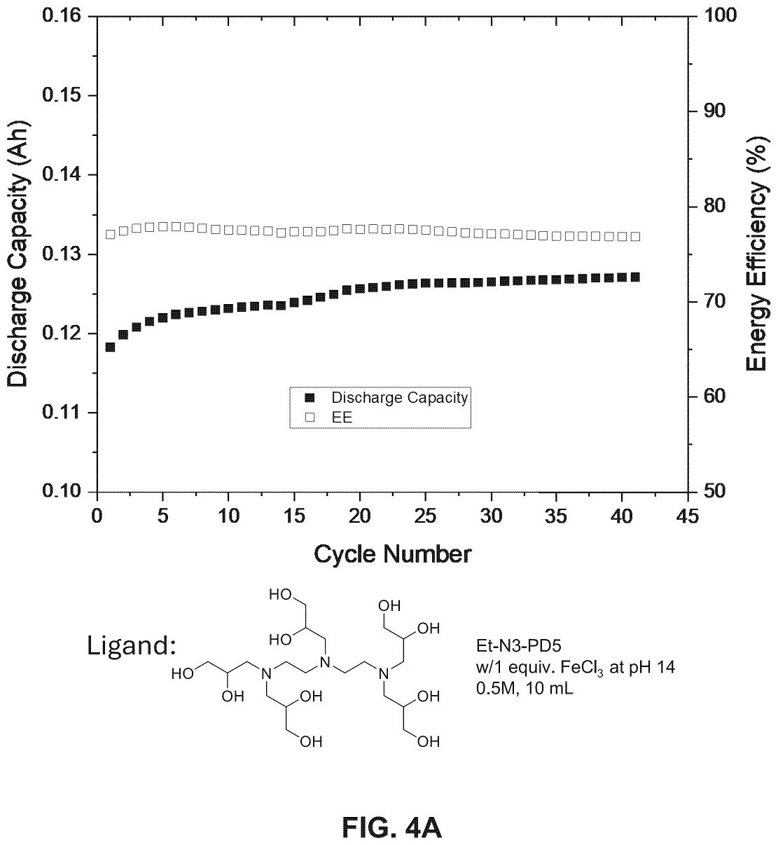

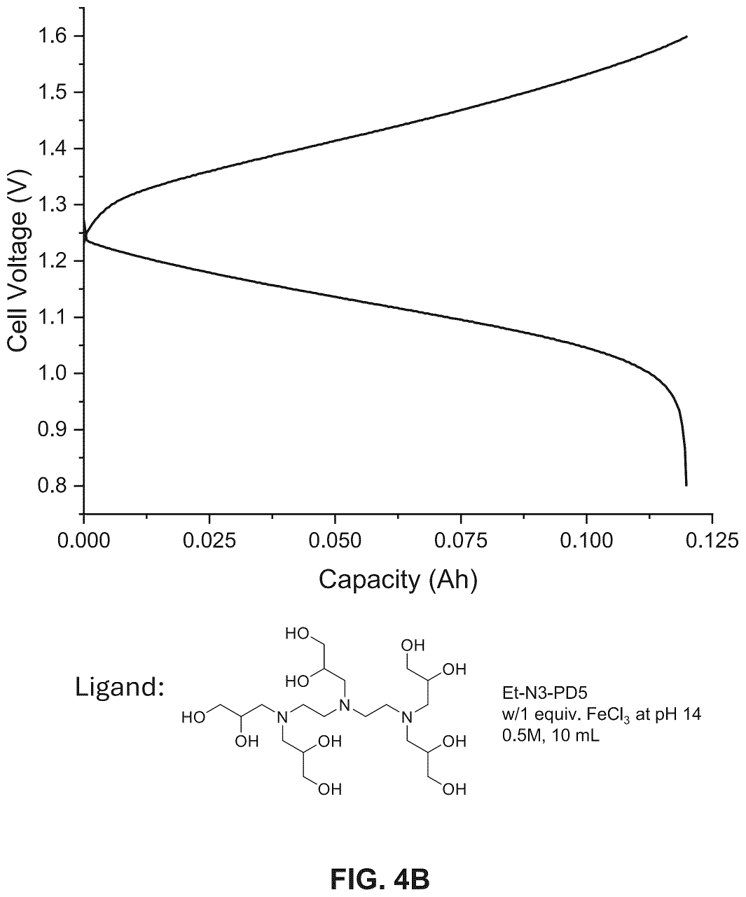

The electrolytes were flowed through an assembled cell and cycled at 20 mA/cm² yielding data provided in FIGS. 4A and 4B. FIG. 4A is a graph showing the discharge capacity and energy efficiency over repeated cycling. FIG. 4B is a graph showing the charge and discharge profiles at pH 14.

The redox flow battery system demonstrated a slightly increasing discharge capacity and EE greater than 75%, and the cell provided stable cycling at 20 mA/cm² over 40 cycles. Therefore, this example demonstrates that the redox flow battery system using an anolyte comprising Et-N2-PD4 supported Fe(III) ions up to pH 14.

### Example 4

In this example, a redox flow battery using an anolyte comprising an iron-ion component and Et-N3-PD3-PHS2 was investigated. The Fe(Et-N3-PD3-PHS2) was prepared by treating Et-N3-PD3-PHS2 in water with a 2.5 mmol solution of FeCl₃ in water with stirring. The mixture was treated with KOH from a stock 10M solution until reaching a pH of 13.20 and a volume of 7 mL. A catholyte of 7 mL volume was prepared with 0.36M ferrocyanide (from equal parts sodium and potassium precursors), 0.07M potassium ferricyanide, and then dropwise addition of stock 10M KOH until a pH of 13.12 was reached.

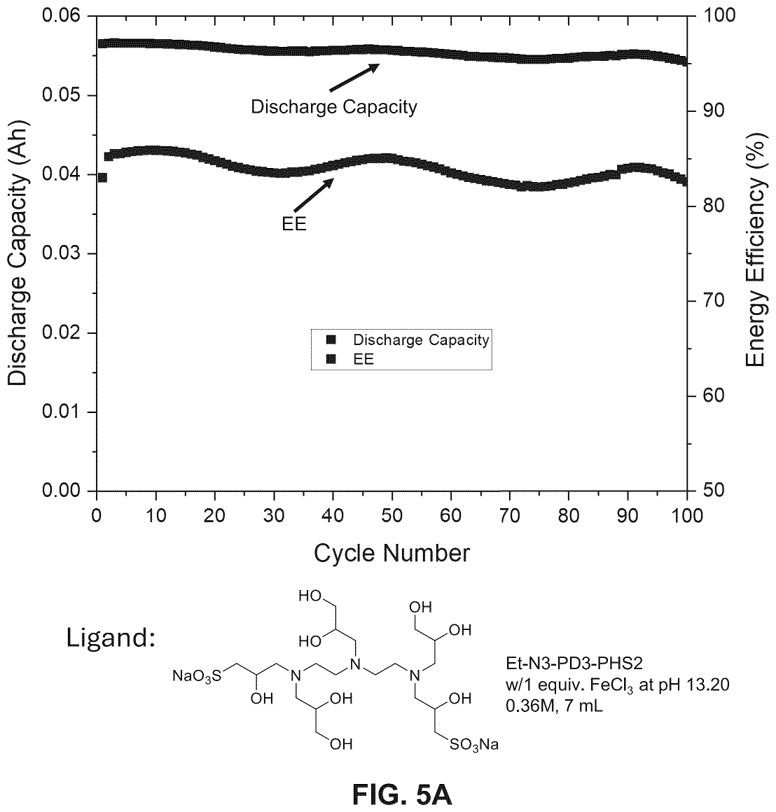

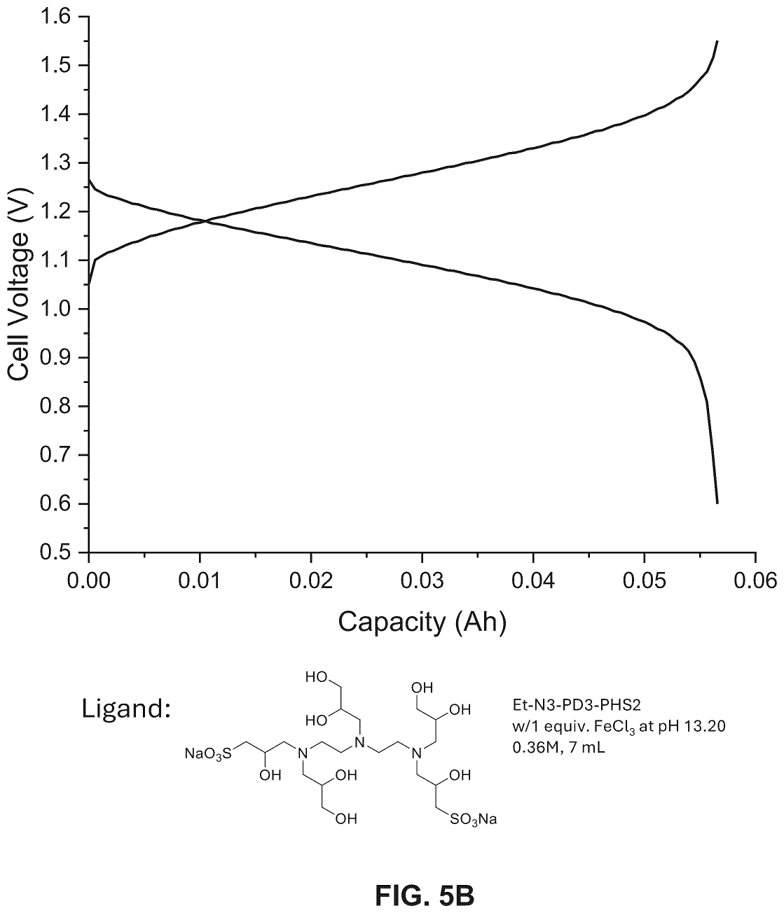

The electrolytes were flowed through an assembled cell at 32 mL/min and cycled at 20 mA/cm² yielding data provide in FIGS. 5A and 5B. FIG. 5A is a graph showing the discharge capacity and energy efficiency over repeated cycling. FIG. 5B is a graph of the charge and discharge profiles at pH 13.2.

The redox flow battery system demonstrated a stable discharge capacity and EE greater than 80%, and the cell provided stable cycling at 20 mA/cm² over 100 cycles. Therefore, this example demonstrates that the redox flow battery system using an anolyte comprising Et-N3-PD3-PHS2 supported Fe(III) ions at pH 13.2.

### Example 5

In this example, a redox flow battery using an anolyte comprising an iron-ion component and Et-N6-PD8 was investigated. The Fe(Et-N6-PD8) was prepared by treating a 5 mmol solution of Et-N6-PD8 in water with a 10 mmol solution of FeCl3 in water with stirring. The mixture was treated with KOH from a stock 10M solution until reaching a pH of 13.32 and a volume of 15 mL. A catholyte of 10 mL volume was prepared with 1.0M ferrocyanide (from equal parts sodium and potassium precursors), 0.2M potassium ferricyanide, and then dropwise addition of stock 10M KOH until a pH of 12.96 was reached.

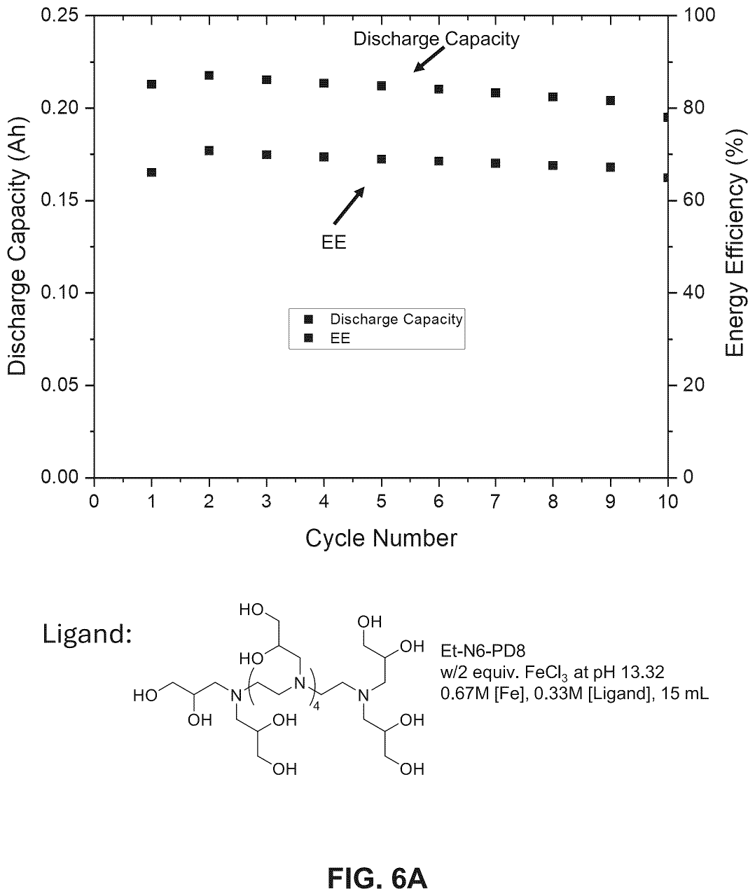

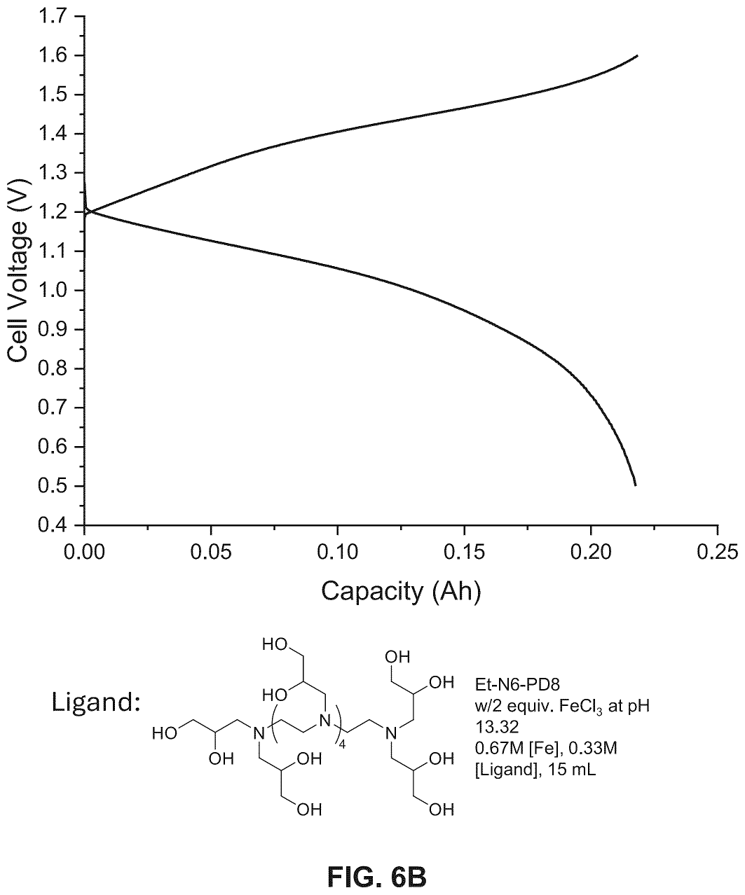

The electrolytes were flowed through an assembled cell and cycled at 20 mA/cm² yielding data provided in FIGS. 6A and 6B. FIG. 6A is a graph showing the discharge capacity and energy efficiency over repeated cycling. FIG. 6B is a graph showing the charge and discharge profiles at pH 13.32.

The redox flow battery system demonstrated a slightly decreasing discharge capacity and EE greater than 60%, and the cell provided stable cycling at 20 mA/cm² over 10 cycles. Therefore, this example demonstrates that the redox flow battery system using an anolyte comprising Et-N6-PD8 supported Fe(III) ions at pH 13.2.

### Example 6

In this example, a redox flow battery using an anolyte comprising an iron-ion component and Et-N580-PD582 was investigated. The Fe(Et-N580-PD582) was prepared by treating a solution of ca. 0.0193 mmol Et-N580-PD582 with a 2.5 mmol solution of FeCl₃ in water with stirring. The mixture was treated with KOH from a stock 10M solution until reaching a pH of 13.14 and a volume of 10 mL. A catholyte of 10 mL volume was prepared with 0.25M ferrocyanide (from equal parts sodium and potassium precursors), 0.05M potassium ferricyanide, and then dropwise addition of stock 10M KOH until a pH of 13.03 was reached.

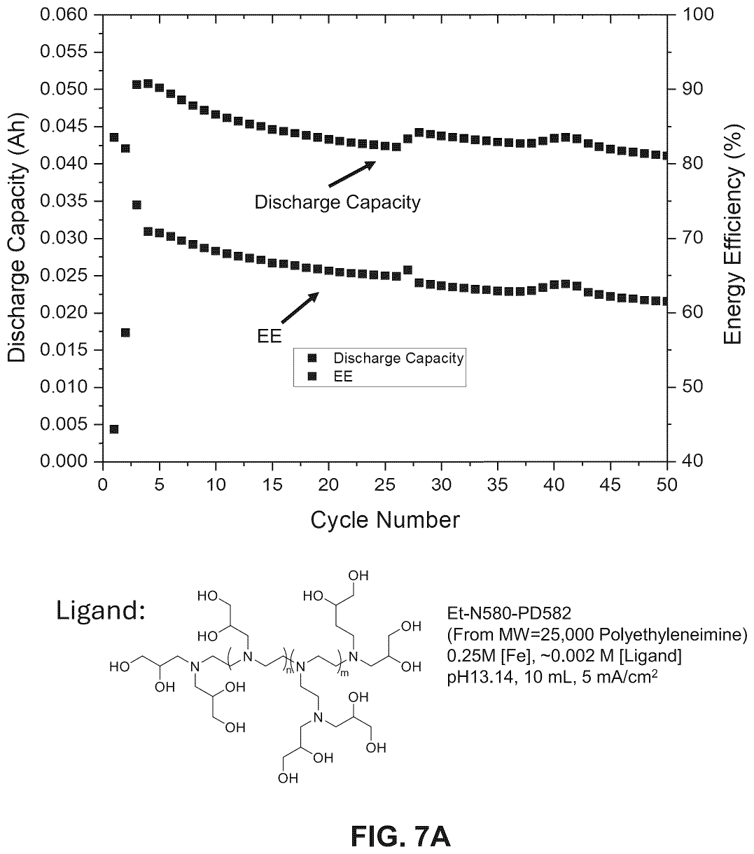

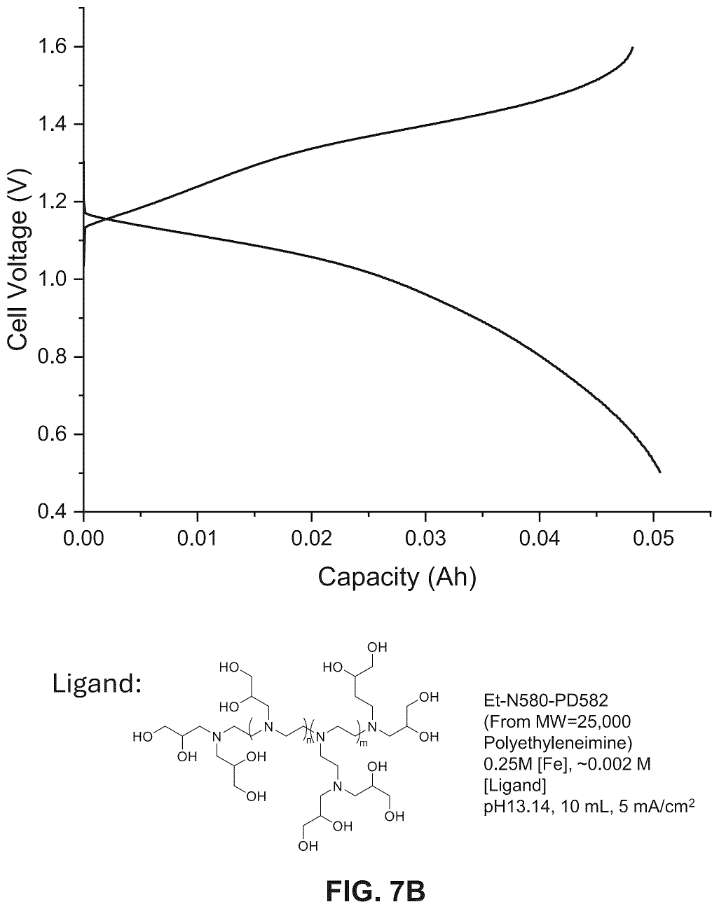

The electrolytes were flowed through an assembled cell and cycled at 5 mA/cm² yielding the data provided in FIGS. 7A and 7B. FIG. 7A is a graph showing the discharge capacity and energy efficiency over repeated cycling. FIG. 7B is a graph showing the charge and discharge profiles at pH 13.14.

The redox flow battery system demonstrated a decreasing discharge capacity and EE greater than 60%, and the cell provided stable cycling at 5 mA/cm² over 50 cycles. Therefore, this example demonstrates that the redox flow battery system using an anolyte comprising Et-N580-PD582 supported Fe(III) ions at pH 13.14.

### Example 7

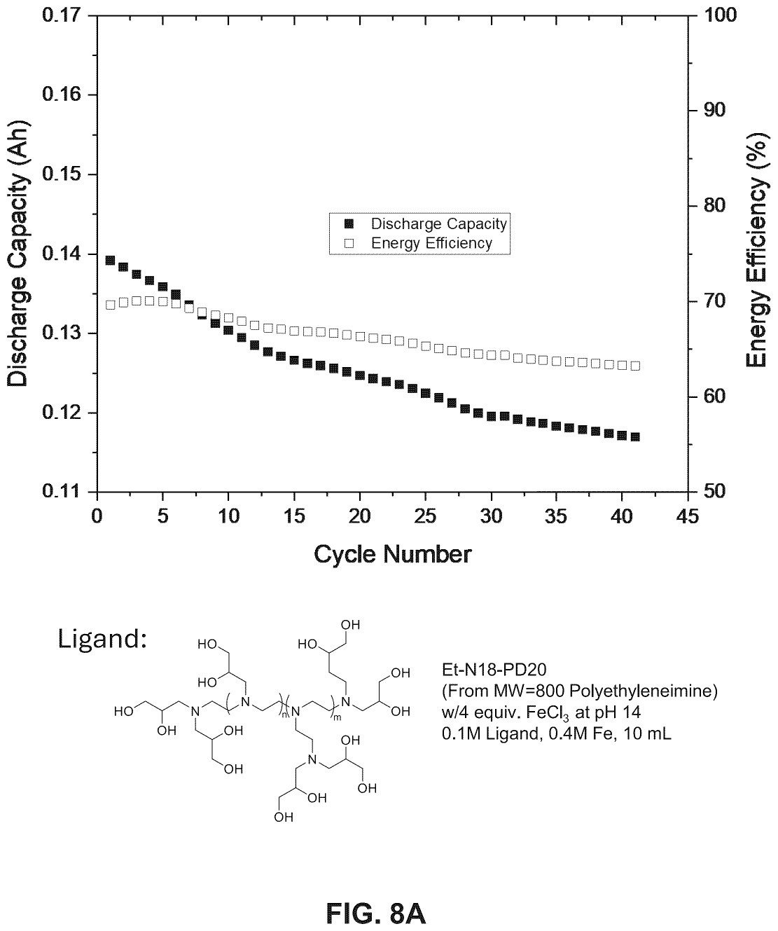

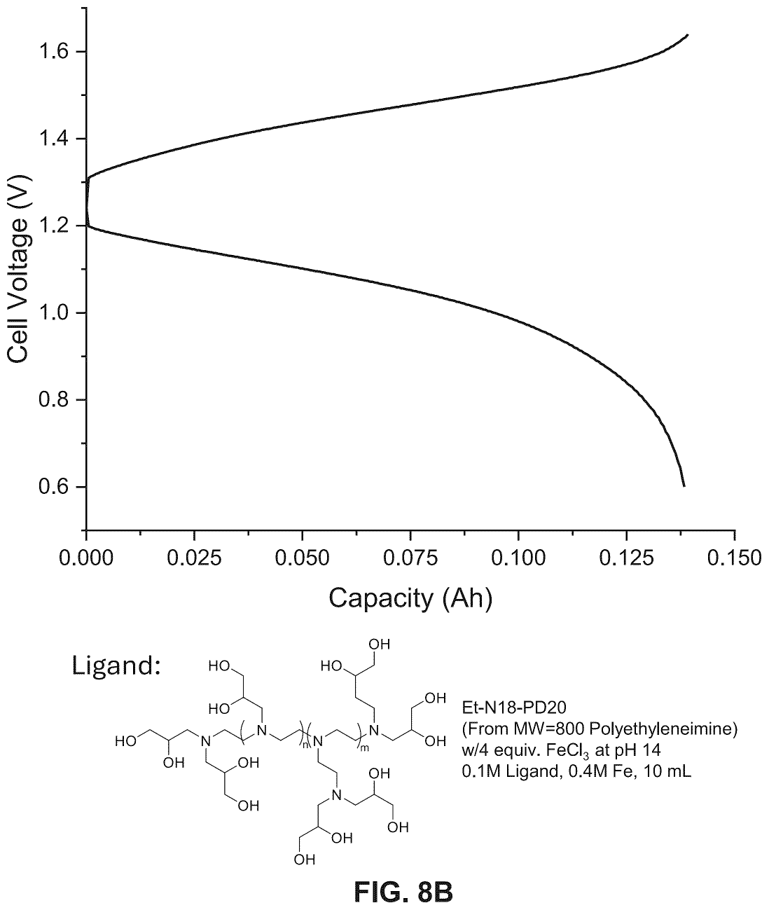

In this example, a redox flow battery using an anolyte comprising an iron-ion component and Et-N18-PD20 was investigated. FIGS. 8A and 8B are graphs illustrating battery cycling data for a redox battery using an anolyte comprising Et-N18-PD20 with 4 equivalents FeCl₃ at pH 14 (0.4 M [Fe], 0.1 M [ligand], 10 mL). FIG. 8A is a graph showing the discharge capacity and energy efficiency over repeated cycling. FIG. 8B is a graph showing the voltage profiles at pH 14.

The redox flow battery system demonstrated a decreasing discharge capacity and EE greater than 60%, and the cell provided stable cycling at a 20 mA/cm² over 40 cycles. Therefore, this example demonstrates that the redox flow battery system using an anolyte comprising Et-N18-PD20 supported Fe(III) ions at pH 14.

### Example 8

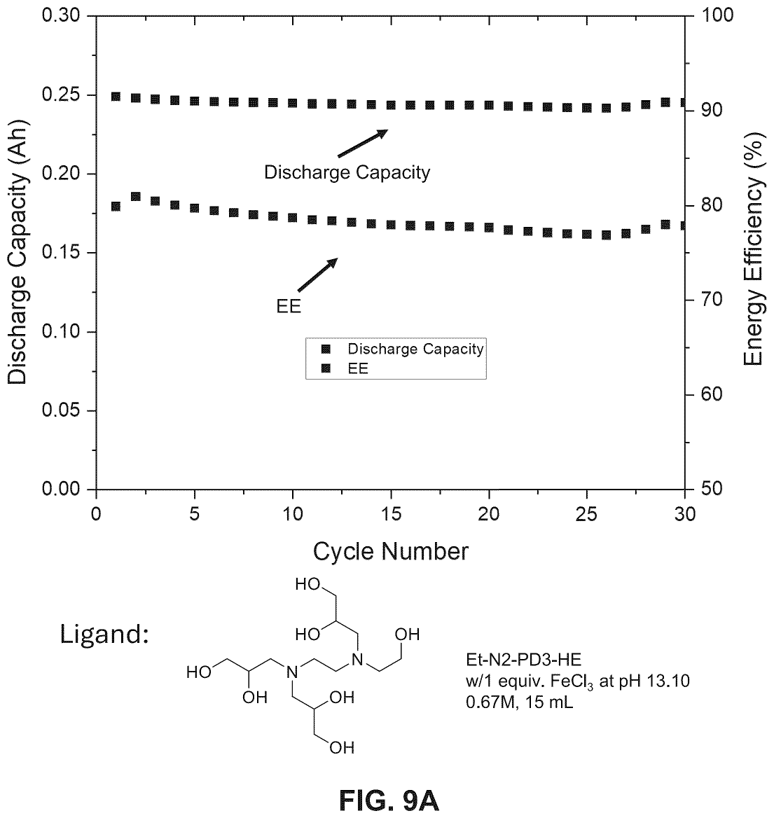

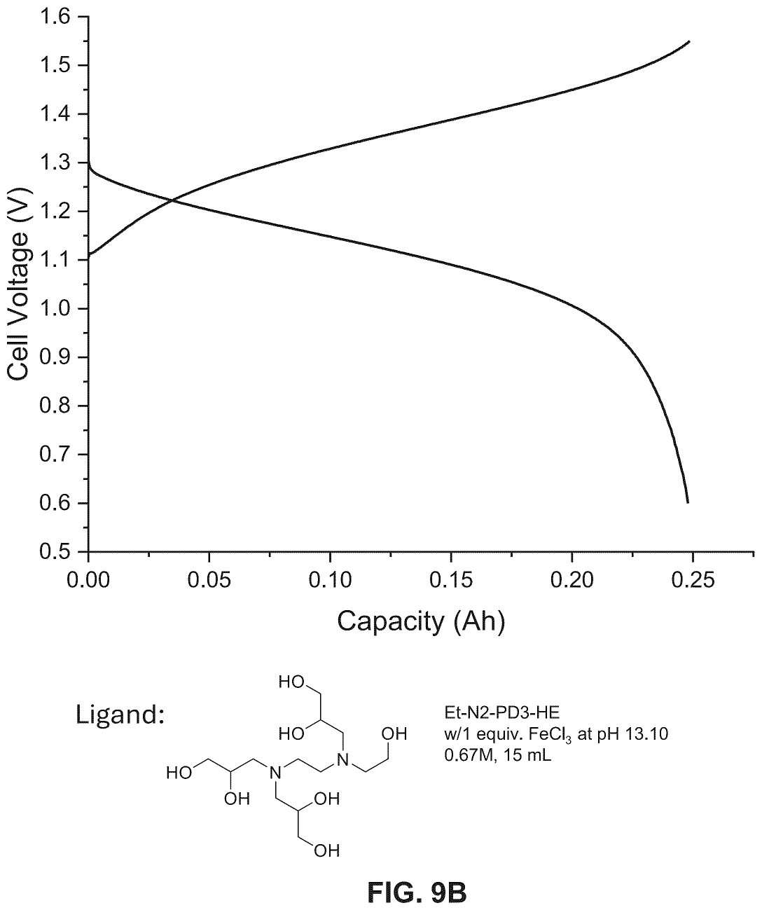

In this example, a redox flow battery using an anolyte comprising an iron-ion component and Et-N2-PD3-HE was investigated. FIGS. 9A and 9B are graphs illustrating battery cycling data for a redox battery using an anolyte comprising Et-N2-PD3-HE with 1 equivalent FeCl₃ at pH 13.10 (0.67 M, 15 mL). FIG. 9A is a graph showing the discharge capacity and energy efficiency over repeated cycling. FIG. 9B is a graph showing the charge and discharge profiles at pH 13.10.

The redox flow battery system demonstrated a stable discharge capacity and EE greater than 75%, and the cell provided stable cycling at a 20 mA/cm² over 30 cycles. Therefore, this example demonstrates that the redox flow battery system using an anolyte comprising and Et-N2-PD3-HE supported Fe(III) ions at pH 13.10.

### Example 9

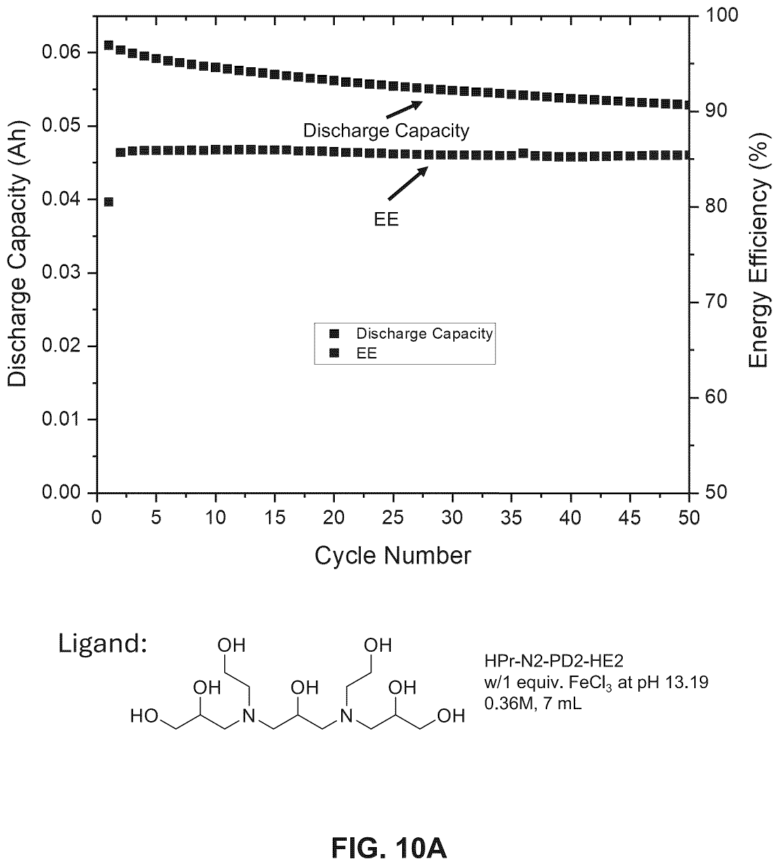

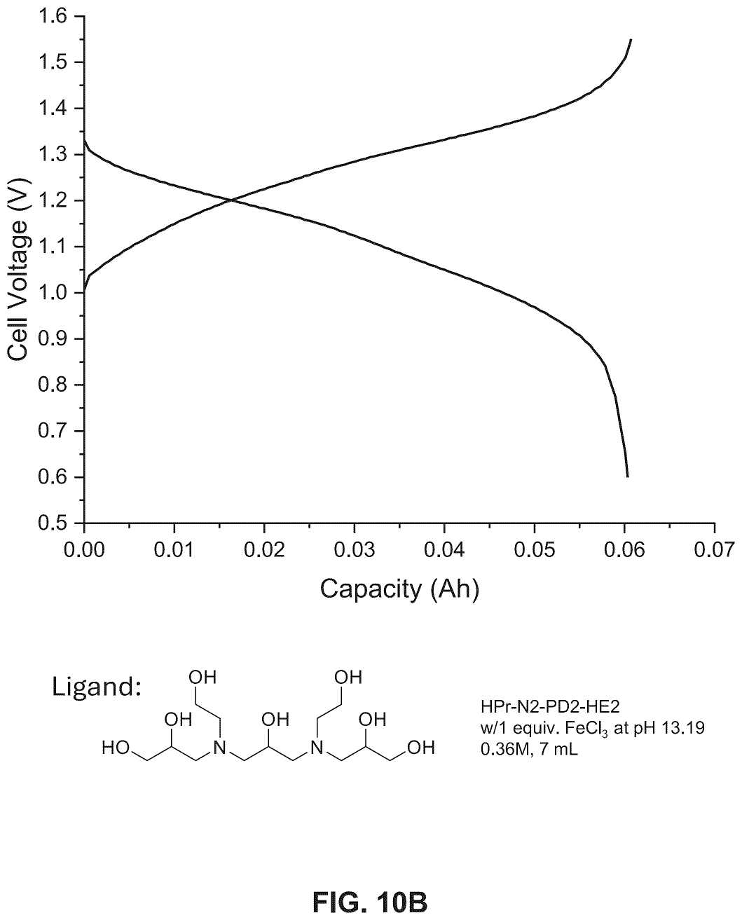

In the example, a redox flow battery using an anolyte comprising an iron-ion component and HPr-N2-PD2-HE2 was investigated. FIGS. 10A and 10B are graphs illustrating battery cycling data for a redox battery using an anolyte comprising HPr-N2-PD2-HE2 with 1 equivalent FeCl₃ at pH 13.19 (0.36 M, 7 mL). FIG. 10A is a graph showing the discharge capacity and energy efficiency. FIG. 10B is a graph showing the voltage profiles at pH 13.19.

The redox flow battery system demonstrated a decreasing discharge capacity and EE greater than 85%, and the cell provided stable cycling at a 20 mA/cm² over 50 cycles. Therefore, this example demonstrates that the redox flow battery system using an anolyte comprising HPr-N2-PD2-HE2 supported Fe(III) ions at pH 13.19.

### Example 10

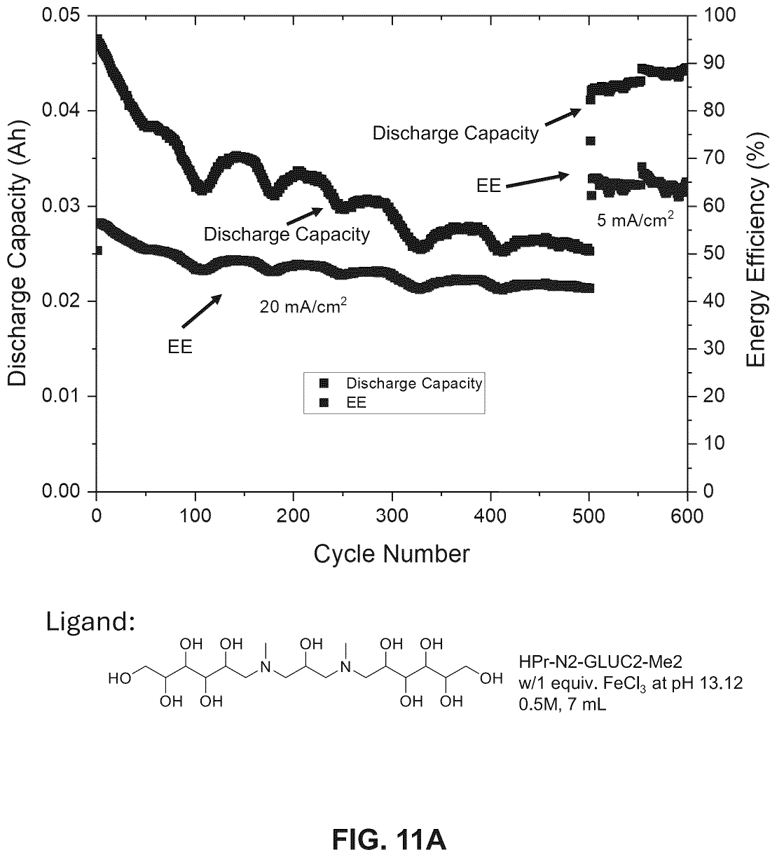

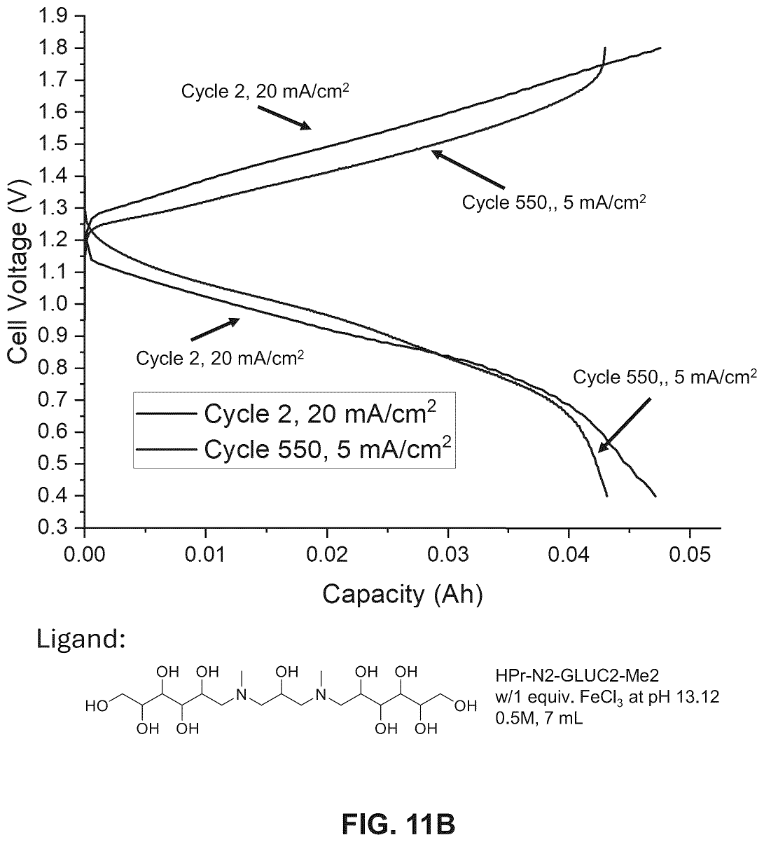

In this example, a redox flow battery using an anolyte comprising an iron-ion component and HPr-N2-GLUC2-Me2 was investigated at 20 mA/cm² cycling and at 5 mA/cm² cycling. FIGS. 11A and 11B are graphs illustrating battery cycling data for a redox battery using an anolyte comprising with 1 equivalent FeCl₃ at pH 13.12 (0.5 M, 7 mL). FIG. 11A is a graph showing the discharge capacity and energy efficiency at 20 mA/cm² cycling and at 5 mA/cm² cycling. FIG. 11B is a graph showing the voltage profiles at pH 13.12.

The redox flow battery system demonstrated a decreasing discharge capacity and EE greater than 40%, and the cell provided stable cycling at 20 mA/cm² over 500 cycles. The redox flow battery system demonstrated an increasing discharge capacity and an EE greater than 60%, and the cell provided stable cycling at 5 mA/cm² from cycles 500 to 600. Therefore, this example demonstrates that the redox flow battery system using an anolyte comprising HPr-N2-GLUC2-Me2 supported Fe(III) ions at pH 13.12.

### Example 11

In this example, a redox flow battery system using an anolyte comprising Et-N2-PD4 was compared to a comparator redox flow battery system using an anolyte comprising triethanolamine (TEOA).

The Fe(Et-N2-PD4) was prepared by treating a 10 mmol solution of Et-N2-PD4 in water with a 10 mmol solution of FeCl₃ in water with stirring. The mixture was treated with 6 equivalents of NaOH from a stock 10M solution and diluted to a final volume of 20 mL. A catholyte of 20 mL volume was prepared with 0.5M potassium ferrocyanide, 0.05M potassium ferricyanide, and 1M NaOH. The electrolytes were flowed through an assembled cell and cycled at 20 mA/cm².

The Fe(TEOA) was prepared by treating a 30 mmol solution of triethanolamine (TEOA) in water with 6 equivalents of NaOH, to which was added a 10 mmol solution of FeCl₃ in water with stirring. The solution was diluted to 20 mL after homogenized. A catholyte of 20 mL volume was prepared with 0.5M potassium ferrocyanide, 0.05M potassium ferricyanide, and 1M NaOH. The electrolytes were flowed through an assembled cell and cycled at 20 mA/cm².

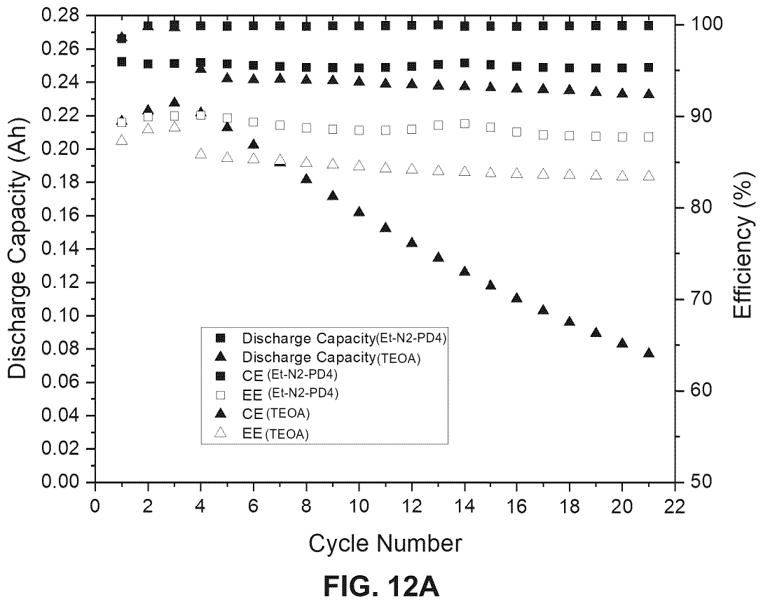

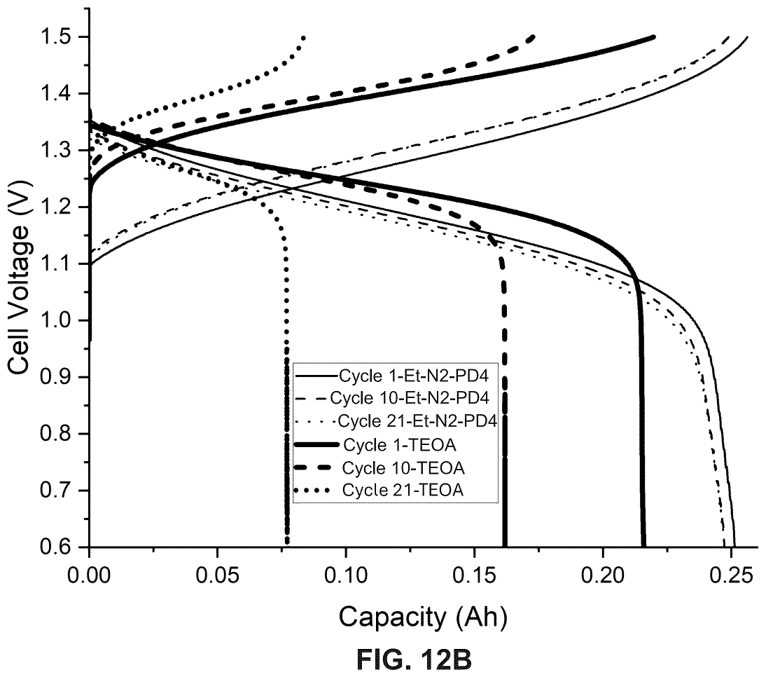

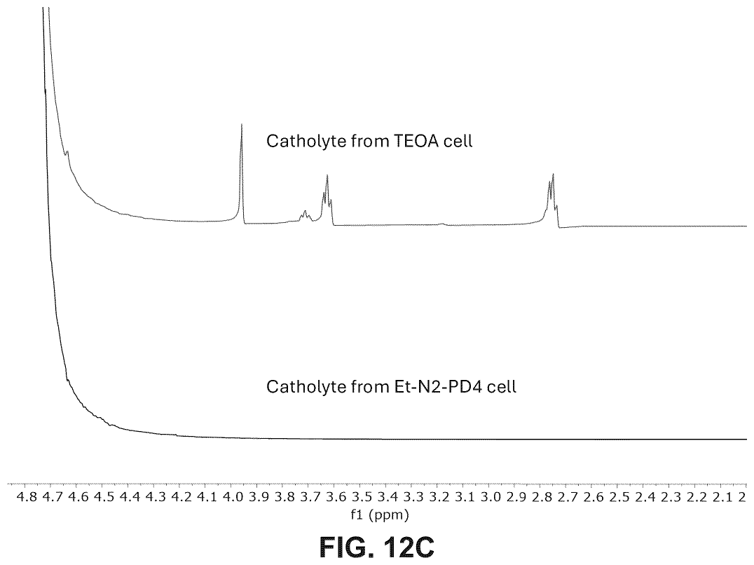

FIG. 12A is a graph showing the discharge capacity for Et-N2-PD4 and TEOA, CE for Et-N2-PD4 and TEOA, and the EE for Et-N2-PD4 and TEOA. FIG. 12B is a graph showing the voltage profiles for N2-PD4 and TEOA at cycles 1, 10, and 21. Accordingly, with reference to the battery flow system using an anolyte comprising Fe(Et-N2-PD4) exhibited a discharge capacity remaining substantially the same over 20 cycles; a CE at or near 100% over 20 cycles; and an EE above 85% over 20 cycles. In contrast, the comparator, the battery flow system using an anolyte comprising TEOA exhibited a discharge capacity that substantially decreased over 20 cycles; a CE that remained at or below 95% over 20 cycles; and an EE that remained below 90% over 20 cycles.

An aliquot of catholyte was removed and analyzed by ¹H-NMR after 50 hours of cycling for both systems to investigate the crossover effect of Et-N2-PD4 and TEOA. FIG. 12C is the ¹H-NMR spectrum of the catholyte comprising TEOA and the ¹H-NMR spectrum of the catholyte comprising Et-N2-PD4. In view of FIG. 12C, the catholyte of the redox flow battery system using an anolyte comprising TEOA exhibited a substantial amount of TEOA crossover. In contrast, the redox flow battery system using an anolyte comprising Et-N2-PD4 did not exhibit such crossover.

FIGS. 12A-12C demonstrate a desirable capacity retention and no ligand crossover for the redox flow battery using the anolyte comprising Et-N2-PD4 in contrast to the redox flow battery using the anolyte comprising TEOA, which demonstrated capacity loss and an undesirable amount of ligand (TEOA) crossover. Accordingly, this example demonstrates that capacity loss and ligand crossover was substantially more in the redox flow battery system using an anolyte comprising TEOA, while capacity retention and a lack of any observed crossover were noted in the redox flow battery system using an anolyte comprising Et-N2-PD4.

In view of the many possible aspects to which the principles of the present disclosure may be applied, it should be recognized that the illustrated embodiments are only preferred examples of the present disclosure and should not be taken as limiting the scope of the present disclosure. Rather, the scope of the present disclosure is defined by the following claims. We therefore claim as our invention all that comes within the scope and spirit of these claims.

We claim:

1. An anolyte, comprising:
an iron-ion component; and
an alkanolamine-based ligand having a structure according to Formula I, 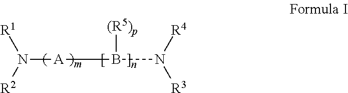
wherein:
A is selected from acyclic aliphatic or acyclic heteroaliphatic;
each B independently for each occurrence is acyclic aliphatic or acyclic heteroaliphatic;
each of R¹, R², R³, and R⁴ independently is selected from hydrogen, aliphatic, or heteroaliphatic;
R⁵ is selected from hydroxyl or heteroaliphatic;
m is an integer selected from 0 or 1;
n is an integer selected from 1 to 500; and
each p independently for each occurrence is an integer selected from 0 or 1;
provided that
(i) if B is aliphatic and p is 0, then B is C₃₋₁₀ aliphatic; and
(ii) at least two of R¹, R², R³, R⁴, and R⁵ independently comprise a heteroaliphatic group comprising at least two hydroxyl groups.

2. The anolyte of claim 1, wherein A, if present, is selected from CH₂, C₂H₄, or C₃H₆; and each B independently has a structure according to Formula II, 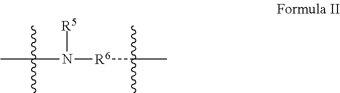
wherein:
R⁵ is heteroaliphatic comprising at least one hydroxyl group; and
R⁶ is selected from C₂₋₁₀ aliphatic or heteroaliphatic.

3. The anolyte of claim 1, wherein any R¹, R², R³, R⁴, or R⁵ that does not comprise the heteroaliphatic group comprising at least two hydroxyl groups independently is a heteroaliphatic group comprising at least one hydroxyl group.

4. The anolyte of claim 1, wherein at least three of R¹, R², R³, R⁴, and R⁵ independently comprise the heteroaliphatic group comprising at least two hydroxyl groups.

5. The anolyte of claim 1, wherein the heteroaliphatic group comprising the at least two hydroxyl groups is a dihydroxypropyl group having a structure —(CH₂)C(H)(OH)CH₂OH.

6. The anolyte of claim 1, wherein the alkanolamine-based ligand has a structure according to Formula IA, 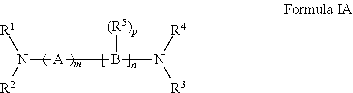
wherein n is 0 and at least three of R¹, R², R³, and R⁴ are —(CH₂)C(H)(OH)CH₂OH.

7. The anolyte of claim 1, wherein the alkanolamine-based ligand has a structure according to Formula IA, 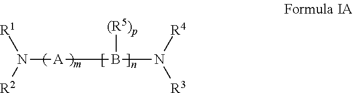
wherein m is zero, n is 1, p is 1, B is aliphatic, and R⁵ is OH.

8. The anolyte of claim 7, wherein two of R¹, R², R³, and R⁴ independently are the heteroaliphatic group comprising the at least two hydroxyl groups and are selected from —(CH₂)C(H)(OH)CH₂OH or —(CH₂)[C(H)(OH)]CH₂OH and any remaining R¹, R², R³, or R⁴ groups are methyl or —(CH₂)₂OH.

9. The anolyte of claim 1, wherein the alkanolamine-based ligand comprises at least two B groups that are different and has a structure according to Formula IB, 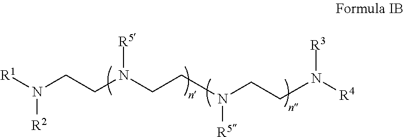
wherein:
each of n′ and n″ independently is an integer selected from 1 to 500, provided that n′+n″=≤500; and wherein each R^{5′} and R^{5″} independently is selected from hydroxyl or heteroaliphatic.

10. The anolyte of claim 1, wherein:
each of m and p is 1;
n is at least 2; and
each R⁵ is —(CH₂)C(H)(OH)CH₂OH.

11. The anolyte of claim 1, wherein any R¹, R², R³, R⁴, or R⁵ that does not comprise the heteroaliphatic group comprising at least two hydroxyl groups independently is heteroaliphatic and is selected from:

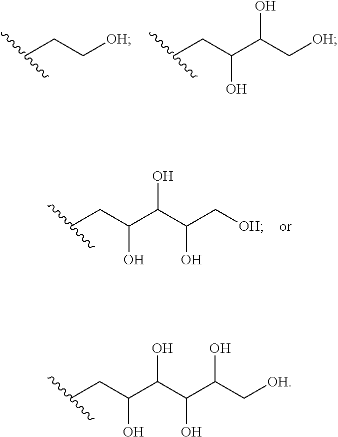

12. The anolyte of claim 1, wherein the alkanolamine-based ligand is selected from:

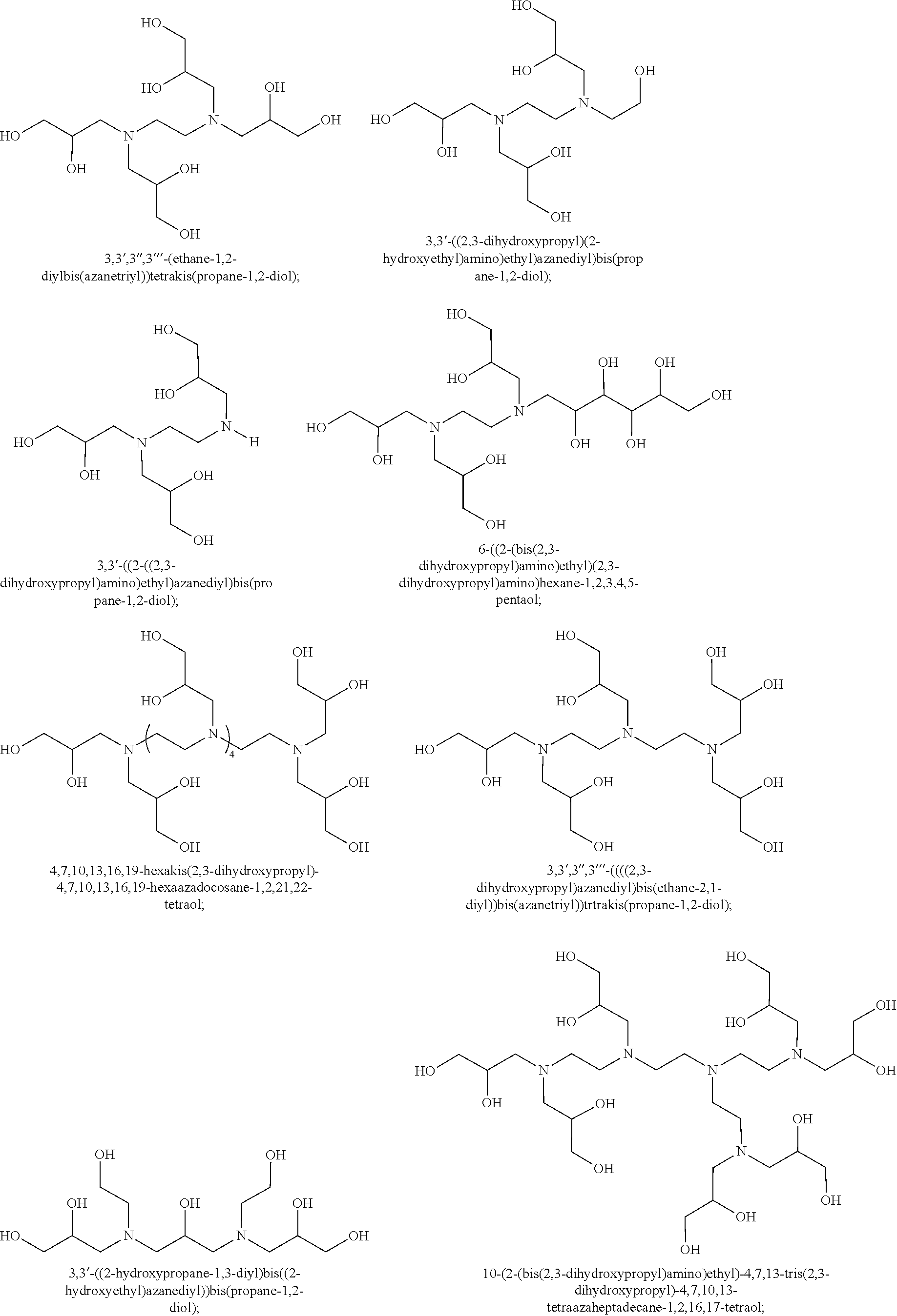

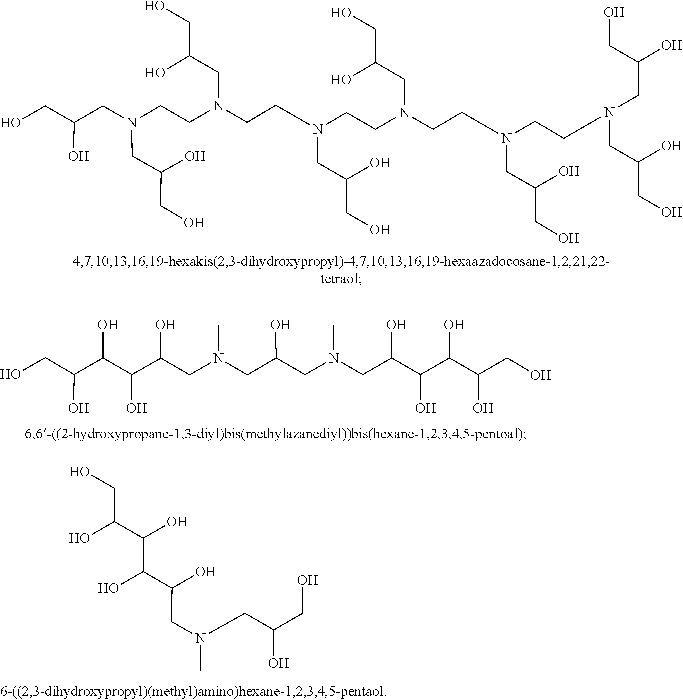 [SMILES: OCC(O)CN(CCN(CCN(CCN(CC(O)CO)CC(O)CO)CC(O)CO)CC(O)CO)CCN(CCN(CC(O)CO)CC(O)CO)CC(O)CO ; CN(CC(O)CN(C)CC(O)C(O)C(O)C(O)CO)CC(O)C(O)C(O)C(O)CO ; CN(CC(O)CO)CC(O)C(O)C(O)C(O)CO]

13. The anolyte of claim 1, wherein at least one of R¹, R², R³, R⁴, or R⁵ has a structure according to Formula III, 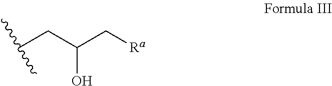
wherein R^{a} comprises a sulfonic acid group or an anion thereof; or a carboxylic acid group or an anion thereof.

14. The anolyte of claim 13, wherein the alkanolamine-based ligand has a structure according to Formula IA, 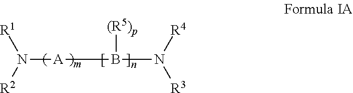
wherein the at least one R¹, R², R³, R⁴, or R⁵ having a structure according to Formula III comprises an R^{a} group that is sulfonic acid or an anion thereof; and n is 1 or 2.

15. The anolyte of claim 13, wherein the alkanolamine-based ligand is selected from:

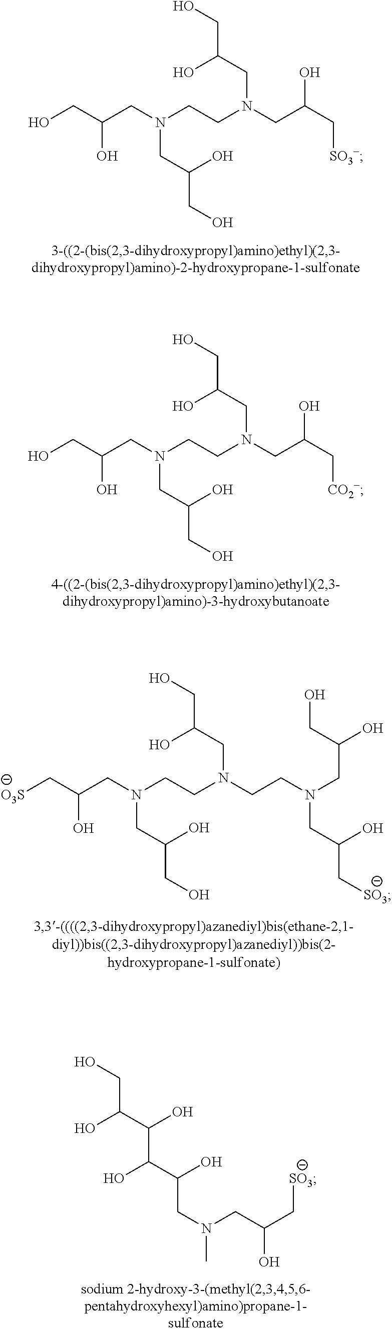

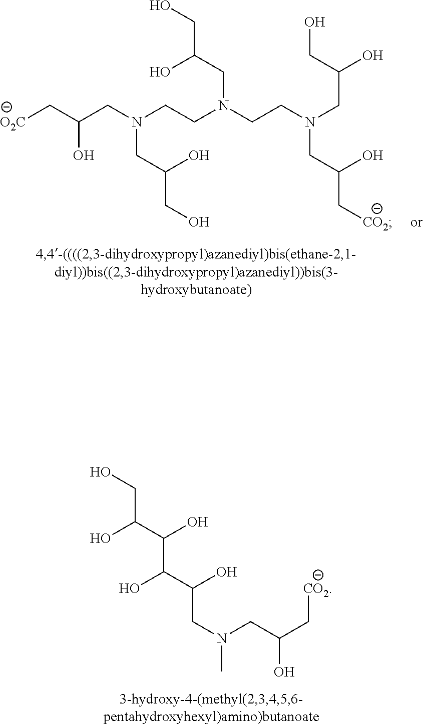

16. The anolyte of claim 1, wherein the alkanolamine-based ligand is coordinated with a plurality of iron-ion components.

17. A redox flow battery system, comprising:
the anolyte of claim 1;
a catholyte; and
an ion selective membrane disposed between the catholyte and anolyte.

18. The redox flow battery system of claim 17, wherein the alkanolamine-based ligand comprises a molecular weight ranging from 150 to 70,000.

19. The redox flow battery system of claim 17, wherein the ion selective membrane comprises a pore size ranging from 1 nm to 250 nm.

20. The redox flow battery system of claim 17, wherein the alkanolamine-based ligand and the iron-ion component of the anolyte are present in amounts providing a ratio of 1:1 alkanolamine-based ligand:iron-ion component.

21. The redox flow battery system of claim 17, wherein the catholyte comprises ferrocyanide.

22. A method, comprising:
placing the anolyte of claim 1 in a redox flow battery system cell comprising a catholyte and an ion selective membrane; and
producing an open circuit voltage ranging from 0.5 V to 2.0 V.
